(19) United States
(12) Patent Application Publication
(10) Pub. No.: US 2026/0001746 A1
(43) Pub. Date: Jan. 1, 2026

(54) Rotating Kingpost Crane With Load Equalizing Bearing

(71) Applicant: Keith Joseph Orgeron, Spring, TX (US)

(72) Inventor: Keith Joseph Orgeron, Spring, TX (US)

(21) Appl. No.: 19/256,122

(22) Filed: Jun. 30, 2025

Related U.S. Application Data
(60) Provisional application No. 63/666,202, filed on Jun. 30, 2024.
(60) Provisional application No. 63/789,214, filed on Apr. 15, 2025.

(51) Int. Cl. B66C 23/16

(52) U.S. Cl. CPC B66C 23/163

(57) ABSTRACT

A heavy-lift rotating kingpin slewing crane is disclosed having an upper bearing for a rotating kingpost crane which achieves equalized radial loading on all boom-side bearing rollers arranged in tandem on approximately a 120 degree arc segment of an upper radial bearing assembly when reacting the crane's operating load-moment couple-forces transferred from the rotating kingpost structure into the stationary kingpost housing at the upper bearing outer race surface. The bearing system comprises a concentrically nested set of load spreader bodies interconnected by pins and arranged to transfer the horizontal couple-forces from each side of the kingpost structure via a linkage to centrally located, largest spreader bodies which progressively reduce and transfer the load radially into smaller spreader bodies until an equal set of radial loads arrive on a set of bearing rollers.

### RELATED APPLICATIONS

This application claims the benefit of U.S. Provisional Application Nos. 63/666,202 filed Jun. 30, 2024, and 63/789,214, filed Apr. 15, 2025, the disclosures of which are hereby incorporated herein by reference in their entirety.

### TECHNICAL FIELD OF INVENTION

The present invention discloses embodiments for large and heavy-lift slewing cranes as may be used offshore, in seaports and on land, for land and marine construction, decommissioning and subsea operations support. The various embodiments disclose a cost-effective, smooth slewing capability to a crane with a rotating kingpost. In particular, the invention relates to cranes having high-capacity load-moment resistance, but with matching high precision, anti-friction bearings afforded high capacity by a novel system for load equivalizing & preload adjustment of the upper bearing.

### BACKGROUND OF INVENTION

Stationary and “rotating” kingpost cranes have been produced for many decades, and they all share several common benefits and drawbacks based on their design features and applications. Both are used on land, marine vessels and platforms, at seaports and on portable skids where features of the support structures are adapted for each crane type. Both typically require nonmetallic bearing surfaces to spare the kingpost perimeter's bearing raceway surface from excess wear, hence, the significantly imprecise slewing movements affected by high sliding friction and “stick-slip” phenomenon. An exception may be port cranes having their kingposts fitted with an inner bearing ring for a bearing raceway.

Cranes with a stationary kingpost design typically feature an inner, cylindrical and partially conical kingpost affixed to a support structure below, the kingpost having a lower cylindrical surface for the nonmetallic lower radial bearing contact and an upper end configured to receive nonmetallic upper radial and axial bearing features and surfaces. The crane's rotating upperworks is arranged to mount the upper and lower bearings and is installed onto the stationary kingpost for full rotation about it.

Cranes with a rotating kingpost design typically feature an outer pedestal (or housing or receptacle) affixed to a support structure below, the kingpost having an upper cylindrical surface for nonmetallic upper radial bearing contact, and configured to receive nonmetallic lower radial and axial bearing features and surfaces near its base. The rotating crane assembly is affixed atop the rotating kingpost and is installed into the pedestal which mounts the upper and lower bearings for full rotation of the kingpost within it.

One option to stationary and rotating kingpost cranes is slew-ring bearing cranes. Slew-ring bearing cranes react all the vertical and lateral forces, and the slewing and overturning moments of a crane, through a single, compound bearing type having large, bolted flange connections below a lower stationary pedestal and above a rotating crane's upperworks.

Precision slewing operation is a chief advantage of these cranes. However, slew-ring bearing cranes have a number of disadvantages. Primary disadvantages of slew-ring bearing include having large, welded, bolted flanges that must interface to the bearing. Another disadvantage is the requirement for hundreds or thousands of bolts for the bearing assembly and installation. Another disadvantage is that large, stiff, high-strength hubs are also required above and below the flanges.

Another disadvantage is that large roller bearing races require custom, large, precision machines and tooling to manufacture. Another disadvantage is that radial and axial slew-ring bearing loads are not distributed equally to all rollers, but reflect approximately a parabolic loading profile.

As a result of the disadvantages listed above, a number of consequential disadvantages are realized. One such disadvantage is the requirement for large part precision machining which is expensive. Another such disadvantage is that large and critical welds must be made on high-grade steels which may require custom made equipment. Another such disadvantage is from large weldment shrinkage and distortion, and post weld and stress-relief heat treating equipment requirements.

Another such disadvantage is that nonuniform roller loading can be as much as twice the average roller load. Another such disadvantage is that bearing life is significantly reduced, resulting in downtime and additional costs. Another such disadvantage is that inspection, repair and service require near complete crane disassembly.

By contrast, kingpost cranes react all the same forces and moments through two bearing locations spread significantly far apart to reduce their magnitudes for safer, simpler, cheaper and more robust and maintainable bearing arrangements and related connections. No welded flanges are in the primary load path. Low life-cycle cost is a chief advantage of these cranes. Some primary disadvantages of this design approach is that precision upper bearings or rollers cannot be practically installed and deployed, and so sliding pad bushings are used in their place.

As a result of the disadvantages listed above, a number of consequential disadvantages are realized. One such disadvantage is that precision slewing operations are not possible when needed for many critical lifts. Another disadvantage is that sliding pad bearings or bushings experience high friction resulting in slip-stick dynamics and imprecise slewing operations. Other disadvantages are that long, relatively slender stationary kingposts deflect a lot, and practically require round profiles to function as the inner slide bearing race, limiting the cross-section optimization possible only with rotating kingposts

In view of the foregoing disadvantages with the present crane slewing technology, there remains a need to provide a high precision slewing capability for a kingpost crane to overcome many of the shortcomings of these common crane designs.

It is also desirable to limit the overall size impact of this bearing arrangement on the crane's design envelope. It is also desirable to provide load distribution features in an upper bearing arrangement that optimizes load equalization. It is also desirable to accommodate application of a preload to the bearing to maintain improved roller-to-race orientation, and reduce surface degradation, wear, lubricant debris contamination, and heat generation.

It is also desirable to preload the outer race to resist elliptical deformation due to the crane's overturning moment force couple reactions. It is also desirable to have a design that facilitates access for inspection, maintenance, and repair or replacement of all components of the bearing arrangement. It is also desirable to optimize the cross-section of the kingpost at various elevations other than circular or annular, such as using trapezoidal shapes that may incorporate economical combinations of flat plate or sandwich panels and/or trusses, wherein space can be allotted for upper bearing segments intermediate the outer pedestal and the boom-side of kingpost.

### SUMMARY OF INVENTION

The present invention is for a novel heavy-lift crane having a high precision slewing capability with its rotating kingpost design. The disclosed embodiments provide a kingpost bearing arrangement that integrates a load-equalizing, radial upper bearing with a shape-optimized rotating kingpost design, allowing for critical space and weight efficiency, and cost savings, overcoming many of the problems and disadvantages of the various slewing, heavy-lift crane designs of the prior art.

For clarity, the “front” of the crane is defined as that three-dimensional space beyond the kingpost rotating axis in the direction towards a horizontal boom tip.

In general, all external loads developed in the crane's boom, gantry and winch systems due to lifted load and component weights are transferred to their respective kingpost pivotal or fixed connections and combined there with the weight of the rotating kingpost assembly. For static crane lifting assumptions, the resulting combined force and moment loads are two-dimensional approximately in a vertical rotating plane coincident with the boom center.

The vertical portion of the load reacts at the thrust bearing located just below the lower radial bearing, while the overturning moment load transforms into a force-couple of opposing horizontal forces vertically spaced to align with the upper and lower radial bearings. This moment transformation also includes the generation of an internal horizontal shear which diminishes as it travels downwards between the upper and lower radial bearings.

The load-equalizing upper bearing is primarily comprised of a set of circumferentially arranged bearing rollers, each comprised of a bearing or bushing pressed into a hardened metal tire, designed to contact and run on the bearing's pedestal outer race. Each pair of adjacent rollers are rotatably mounted in a roller shoe, one on each end.

All shoes function to spread or distribute portions of the crane's upper horizontal force, a part of the force couple resolving the overturning moment between the crane's upper and lower bearings.

The load applied to the kingpost arrives at each shoe's pivot point located between its two ends. This horizontal force travels from the kingpost to the roller shoes through a series of nested spreaders concentrically arranged and arrives at the shoe's pivot point.

The bearing assembly is arranged in a substantially horizontal plane extending in two halves symmetrically from the left and right portions of the outer race inwards and converging towards the central region of the rotating kingpost structure, encompassing a segment towards and centered on the boom of approximately 120 degrees and a segment opposite and centered on the boom of approximately 60 degrees.

For all layers of elements in the load transfer network, each spreader element has a pinned connection near its center to the end of a spreader element of the next inner layer.

Both left and right halves of the spreader assembly, each comprising part of the load transfer network, share and distribute the horizontal force reactions, generated by the crane's payload, deadload and other load components in a vertical center-plane of boom rotation, to the bearing outer race from the rotating kingpost where the central region of the spreader assembly is interconnected to both left and right sides of the rotating kingpost structure.

The central region of the spreader assembly includes roller shoes, spreaders, links and other pivoting elements that provide load equalizing, preloading, adjustment, and locking features to the bearing assembly.

The central region of the spreader assembly allows continuity of the spreader assembly and the rotating kingpost structural weldment as each passes through the other, maximizing bearing roller load-equalization while minimizing space requirements. This is primarily accomplished by selective design of the front cross-bracing of the rotating kingpost weldment and the roller spreader elements in that region.

The crane's horizontal loading from both left and right sides, perpendicular to the plane of boom rotation, is reacted into the kingpost structure directly by a set of side roller shoe elements, avoiding the front and rear upper bearing's load transfer network altogether.

These side rollers also accomplish limiting the elliptical deformation and stresses of the outer race given the segmented nature of the load-equalizing upper bearing assembly.

All vertical loads travel directly down the kingpost structure into the lower bearing assembly's thrust bearing, and all lower horizontal force couple loads generated from overturning moments in any vertical plane travel directly down the kingpost structure into the lower bearing assembly's radial bearing.

Both thrust and radial bearings in the lower bearing assembly are small enough in diameter to be commercially available, manufactured products that can be ordered or inventoried for planned bearing replacements. This is accomplished by the custom design wherein the kingpost structure is tapered from a larger top section to a much smaller bottom section where it is adapted to facilitate precise mounting, assembly, installation, and replacement of commercial bearings.

The load-equalizing upper bearing assembly, including the side roller shoe elements, is given access space for operating the adjustable preloading functions for inspection, maintenance, repairs, and replacement by providing human access spaces above and below the assembly which is approximately within the diametral space of the top of the stationary pedestal and the front, rear, central, and sides of the rotating kingpost structure.

Given that the only bearing contact is between the bearing rollers and the outer race, and that access to the bearings is so convenient, oil or grease or no lubrication are all real possibilities. The bearing loads and stresses are significantly lower due to elimination of the large, peak radial loading caused by approximately parabolic load distribution profiles. This allows for lower grade bearing materials and surface finishes, and/or no lubrication, or only enough lubrication to continually wet the outer race which can be completely enclosed within the pedestal under the crane.

The outer race can be inspected and cleaned by retracting the load-equalizing upper bearing assembly's actuators be they screw-jacks or hydraulic cylinders that control adjustable preloading and allow for installation clearance.

While the bearing is retracted, any of the roller spreader elements can be inspected and replaced with readily available spare parts.

The present invention is a rotating kingpost and bearing assembly primarily for heavy-lift cranes. This invention discloses a kingpost housing of vertical elongation affixed to a main support structure near its lower bearing mount, having an upper collar to support loads generated at its upper bearing race located inside. A removable lower bearing box will house, align and protect the lower bear set and this box connects to the lower bearing mount.

A slew axis is defined extending vertically through the centers of the lower bearing mount and the upper bearing race, and said axis is shared with a rotating kingpost having an upper end where a boom, gantry, and winch and slew machinery are connected. The kingpost's lower end is configured to fit a lower bearing set which fits into a lower bearing box.

The rotating kingpost has linkage anchor lugs affixed on each side at the elevation of the upper bearing race whereupon a plurality of bearing rollers of a bearing assembly are engaged with the upper bearing race of the kingpost housing. The upper bearing assembly's bearing rollers are interconnected with a nested spreader assembly.

A linkage mechanism interconnects the spreader assembly and the linkage anchor lugs affixed to the rotating kingpost, wherein the crane's various loads combine at the rotating kingpost upper end. The resulting vertical load and force couple are transferred down the rotating kingpost to the lower end where the vertical and horizontal forces are applied at the lower bearing set. An opposite horizontal force is applied at the upper bearing assembly transferring through the welded linkage anchor lugs, and the linkage mechanism, and into the spreader assembly where the loads are transformed into force-equalized, radial loads at the bearing rollers.

The horizontal loads at the upper bearing assembly are forward in a direct to urge the linkage anchor lugs to the front as a small deflection of the overall rotating kingpost crane assembly of components sharing the load.

The upper bearing assembly is comprised of a trio of bearing assembly segments, each comprising a nested spreader segment, the distal radii of which house a plurality of bearing rollers engaged on the upper bearing race. A linkage mechanism interconnects these spreader segments with the linkage anchor lugs affixed to the kingpost through a few transition spreaders, all spreaders and links pivotal about axes parallel to the slew axis.

The front two, symmetrical, nested spreader segments provide operational radial load resistance while slewing, while the rear one nested spreader segment provides stability for inadvertent load reversal to the rear.

The spreader assembly, in detail, comprises a plurality of spreaders of spreaders with radius A, each mounting a pair of bearing rollers which are pivotally connected to half as many spreaders of radius B which are each pivotally connected to half as many spreaders of radius C, where spreader centroids' radii are defined by the inequality:
radius A>radius B>radius C.

Transition spreaders interconnect spreader segments and the linkage mechanism.

The linkage mechanism comprises a symmetric, left and right, pair of toggle links which rotate inward by actuator force applied to a drive link, radially expanding all three spreader segments into hard contact with the upper bearing race, effectively locking the front bearing assembly segments into position. The drive link rotation also applies radial force to the rear bearing segment for stability as explained.

### BRIEF DESCRIPTION OF DRAWINGS

FIG. 1 is an upper 3D view of an embodiment of a precision slewing heavy-lift crane with a rotating kingpost of the present invention.

FIG. 2 is an upper 3D view of the embodiment illustrated in FIG. 1 of a precision slewing heavy-lift crane with a rotating kingpost.

FIG. 3 is an upper 3D exploded view of the embodiment illustrated in FIG. 1 of a precision slewing heavy-lift crane with a rotating kingpost, showing the rotating kingpost assembly complete with the rotating kingpost, the upper bearing and slew drive assemblies, the kingpost housing, the pedestal base, and the vessel hull or other support structure. In this embodiment, the pedestal base is affixed to the vessel hull, and the kingpost housing is connected to it.

FIG. 4 is an upper 3D exploded, partial section view of the embodiment illustrated in FIG. 1 illustrating the front upper bearing assembly, its outer race, and the lower bearing assembly, and its outer races within the bearing box.

FIG. 5 is an upper 3D view of the embodiment illustrated in FIG. 1 showing only the rotating kingpost assembly.

FIG. 6 is an b 3D view of the embodiment illustrated in FIG. 1 showing a zoomed view upper bearing assembly, the slew drives, and the front and rear upper bearing support decks.

FIG. 7 is an upper 3D view of an alternate embodiment of the current invention showing the kingpost housing without an outer pedestal. In this embodiment, the kingpost housing is affixed directly to the vessel hull or other main support structure.

FIG. 8 is an upper 3D partial section view of the embodiment illustrated in FIG. 7 showing the relative fit relationships between the bearings and their races, and the relative clearances between the kingpost housing and the rotating kingpost assembly.

FIG. 9 is an upper 3D exploded partial section view of the embodiment illustrated in FIG. 7 showing more of the kingpost housing. The lower bearing mount, typically connected to the lower end of the kingpost housing is independent from the housing.

FIG. 10 is a lower 3D partial section view of the embodiment illustrated in FIG. 7 showing the same parts as FIG. 9 but from below for added clarity.

FIG. 11 is an upper 3D exploded view of the embodiment illustrated in FIG. 7 showing the breakdown of the various bearing and slew drive assembly components. Specifically, the front and rear upper bearing subassemblies, the slew drives, the lower radial bearings and the thrust bearing.

FIG. 12 is a lower 3D view of the embodiment illustrated in FIG. 7 showing more details of the kingpost weldment, such as underneath the front and rear upper bearing assembly support decks.

FIG. 13 is an upper 3D view of the embodiment illustrated in FIG. 7 with the boom, slew drive assemblies, slew gear, or slew deck assembly, removed for clarity showing the slew gear and many of the bearing rollers and spreaders and linkage mechanism components of the upper bearing assembly.

FIG. 14 is an upper 3D view of the embodiment illustrated in FIG. 7 showing only the front and rear upper bearing assemblies and the upper bearing linkage mechanism within the kingpost housing and adjacent to the kingpost structure, also showing the slew gear.

FIG. 15 is a lower 3D view of the embodiment illustrated in FIG. 7 showing only the front and rear upper bearing assemblies and the upper bearing linkage mechanism within the kingpost housing and adjacent to the kingpost structure, also showing the slew gear and slew drives.

FIG. 16 is an upper 3D view of the embodiment illustrated in FIG. 7 showing only the upper bearing assembly in its preloaded, extended configuration for operations, with all of its components including the two linkage anchor lugs to the insides of the kingpost weldment.

FIG. 17 is an upper 3D view of the embodiment illustrated in FIG. 7 showing only the upper bearing assembly in its clearance, retracted configuration for maintenance, with all of its components including the two linkage anchor lugs to the insides of the kingpost weldment.

FIG. 18 is an upper plan partial section view of the embodiment illustrated in FIG. 7 showing some of the crane without the boom assembly, slew drives and decks.

FIG. 19 is an upper 3D exploded view of the embodiment illustrated in FIG. 7 showing only the upper bearing assembly components.

FIG. 20 is an upper plan view of the embodiment illustrated in FIG. 7 showing only the right-hand side of the outer spreader layer of roller shoes and the next two inner spreader layers of spreaders and how they can be interconnected to achieve load equalization.

FIG. 21 is an upper 3D view of an alternate embodiment of the present invention as an offshore tower crane having a segmented, extensible mast fed through the pedestal opening shown.

FIG. 22 is an upper 3D exploded view of the embodiment illustrated in FIG. 21 showing the offshore tower crane with its kingpost housing connected to a mast section extension which is set within and connected to the pedestal base which is affixed to the vessel hull or other support structure, having jacking means for raising the tower crane mast in sections.

FIG. 23 is an upper 3D view of the embodiment illustrated in FIG. 21 showing the offshore tower crane with three mast section extensions.

FIG. 24 is an upper 3D view of the embodiment illustrated in FIG. 21 showing the base region of the offshore tower crane with its tower jacking capability disclosed as a mast jacking elevator embedded within the vessel deck.

FIG. 25 is an upper 3D view of the embodiment illustrated in FIG. 21 showing only the vessel hull with the tower jacking elevator extended up above it by hydraulic cylinders.

FIG. 26 is an upper 3D view of the embodiment illustrated in FIG. 21 showing only the vessel hull with the tower jacking elevator retracted down into it by hydraulic cylinders.

FIG. 27 is an upper 3D exploded view of the embodiment illustrated in FIG. 21 showing only the tower jacking elevator outer frame and the mechanical reeving assembly of the hydraulic cylinders used for jacking including wire rope, sheaves yoke frames and anchor point lugs.

FIG. 28 is an upper 3D view of an alternate embodiment of the present invention showing a tendon-stiffened offshore tower crane having an active moment compensation system embedded into the vessel hull for crane stability at the top of the mast where outrigger features distribute compression loading to the kingpost housing and the tendons are pulled down to their anchor point below the deck to tension actuators.

FIG. 29 is an upper 3D view of the embodiment illustrated in FIG. 28 more clearly showing all four tendons, which could also be six, eight or more tendons depending on mast height, moment and seastate loading.

FIG. 30 is a lower 3D view of the embodiment illustrated in FIG. 28 more clearly showing the kingpost housing upgraded with outriggers, bracing and yoke features for stability.

FIG. 31 is an upper 3D view of the embodiment illustrated in FIG. 28 more clearly showing the active moment compensation tendon tensioners represented as hydraulic cylinders.

FIG. 32 is an upper 3D view of an alternate embodiment of the present invention showing a portable, short land crane application with the kingpost housing set within a set of outriggers.

FIG. 33 is an upper 3D view of an alternate embodiment of the present invention showing the upper portion of a seaport traveling crane to be fitted onto the traveling base portion below it.

FIG. 34 is an upper 3D view of an alternate embodiment of the present invention showing a land tower crane with the base mast section, essentially a pedestal base support, to be set into an underground foundation.

FIG. 35 is an upper 3D view of an alternate embodiment of the present invention showing an offshore crane fitted with a block guidance system.

FIG. 36 is an upper 3D view of the embodiment illustrated in FIG. 35 showing the block guidance system at the crane deck elevation.

FIG. 37 is an upper 3D view of the embodiment illustrated in FIG. 35 showing the block guidance system at the highest block elevation.

FIG. 38 is an upper 3D view of the embodiment illustrated in FIG. 35 showing a side view of the block guidance system at the crane deck elevation with the block latching pins (hidden) engaged.

FIG. 39 is an upper 3D view of the embodiment illustrated in FIG. 35 showing a side view of the block guidance system at the crane deck elevation with the block latching pins released from block receptacles.

FIG. 40 is a schematic drawing of the embodiment illustrated in FIG. 35 of a passive, master-slave cylinder arrangement selected to automatically synchronize the two block guidance mechanisms on the left and right sides of the boom without other controls.

FIG. 41 is an upper 3D view of the embodiment illustrated in FIG. 1 illustrating only the upper front and rear bearing assemblies having a single row of rollers.

FIG. 42 is an upper 3D view of the embodiment illustrated in FIG. 1 showing only the full set of upper bearing assembly components including the left and right side stabilizer roller shoe spreader assemblies used here as passive, side stabilizer assemblies attached to lugs on the rotating kingpost exterior, illustrating all rollers having a single row.

FIG. 43 is an upper 3D view of the embodiment illustrated in FIG. 1 illustrating only an alternate embodiment of the upper bearing assembly and the left and right side roller shoe assemblies used here as passive, side stabilizer assemblies attached to lugs on the rotating kingpost exterior, illustrating all rollers having a double row.

FIG. 44 is an upper 3D view of the embodiment illustrated in FIG. 1 and FIG. 43 illustrating the double row upper bearing assembly which can be compared to FIG. 6, the bearing having only a single row.

FIG. 45 is an upper 3D view of the embodiment illustrated in FIG. 1 and FIG. 43 illustrating a detail of the upper left double row upper bearing assembly which can be compared to FIG. 20, the bearing having only a single row.

FIG. 46 is an upper 3D exploded view of the embodiment illustrated in FIG. 1 and FIG. 43 illustrating the double-row upper bearing assembly with a one double-row roller shoe assembly separated from its connecting spreader.

FIG. 47 is an upper 3D exploded view of the embodiment illustrated in FIG. 1 and FIG. 43 illustrating a detail of the double-row upper bearing assembly with all parts of one double-row roller shoe assembly separated from its connecting assembly.

FIG. 48 is an upper 3D view of the embodiment illustrated in FIG. 1 illustrating an alternate embodiment of the upper bearing assembly with all of the spreaders identical but having different roller shoes that include inner race segments accommodating more common bearing cylindrical roller elements that contact the kingpost housing outer race.

FIG. 49 is an upper 3D view of the embodiment illustrated in FIG. 1 and FIG. 48 illustrating the upper bearing assembly accommodating more common bearing cylindrical roller elements that can be compared to FIG. 6 and FIG. 45.

FIG. 50 is an upper 3D view of the embodiment illustrated in FIG. 1 and FIG. 48 illustrating the upper bearing assembly accommodating more common bearing cylindrical roller elements. This configuration can be mostly compared to FIG. 43 and FIG. 44, however, as the linkage mechanism is required but not shown.

FIG. 51 is an upper 3D exploded view of the embodiment illustrated in FIG. 1 and FIG. 48 illustrating the upper bearing assembly accommodating more common cylindrical roller elements.

FIG. 52 is an upper 3D view of the embodiment illustrated in FIG. 1 and FIG. 7 illustrating the entire spreader assembly, comprised of two front spreader segments and one rear spreader segments, and includes transition spreaders that provide equalized load transfer from the linkage mechanism to the bearing rollers.

### DETAILED DESCRIPTION OF PREFERRED EMBODIMENTS

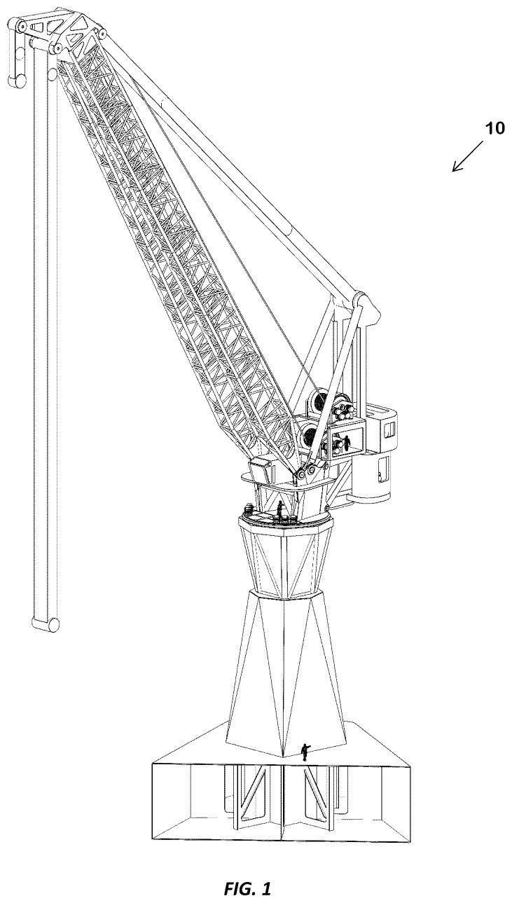

FIG. 1 is an upper 3D view of an embodiment of a rotating kingpost crane 10 of the present invention.

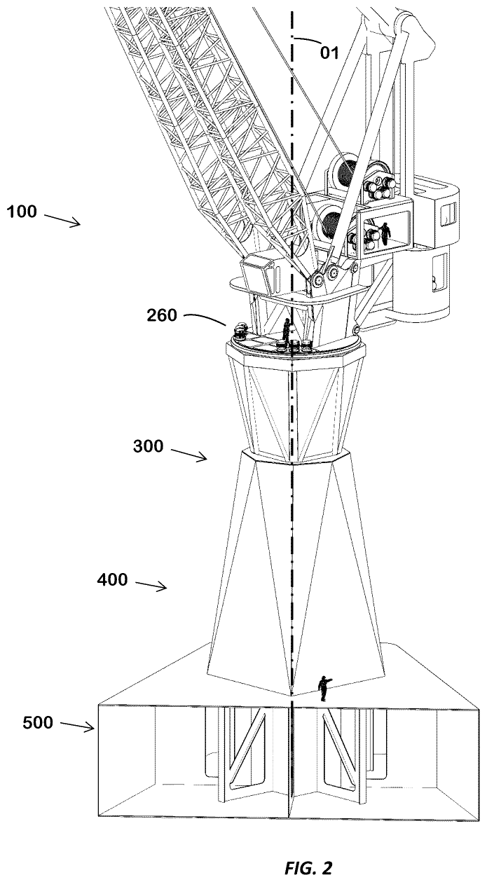

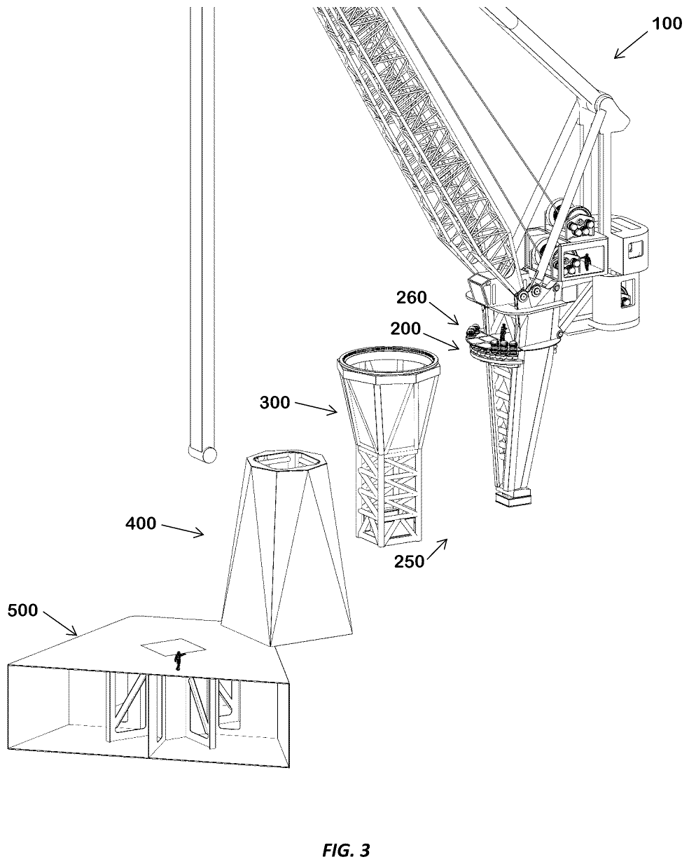

FIG. 2 is an upper 3D view of the embodiment illustrated in FIG. 1 of an offshore rotating kingpost crane 10. In this view, the primary assemblies are identified. A rotating kingpost assembly 100 is rotatably mounted within a kingpost housing 300 on upper and lower bearings (FIG. 3) and rotated by a slew gear assembly 260 above it. Kingpost housing 300 is mounted to a pedestal base 400. In the exemplary embodiment, pedestal base 400 is mounted to a vessel hull 500. Although illustrated with pedestal base 400 connected to vessel hull 500, it will be appreciated that kingpost housing 300 can be structurally expanded and configured to include all features required of pedestal base 400 to be connected directly to vessel hull 500 or other support structure such as a loading dock, pier, or drilling platform.

FIG. 3 is an upper 3D exploded view of the embodiment illustrated in FIGS. 1 and 2, showing rotating kingpost assembly 100 having an upper bearing assembly 200, a lower bearing assembly 250, and slew drive assembly 260. Separately visible are kingpost housing 300, pedestal base 400, and vessel hull 500 or other support structure. In this embodiment, pedestal base 400 is affixed to vessel hull 500, and kingpost housing 300 is connected to it.

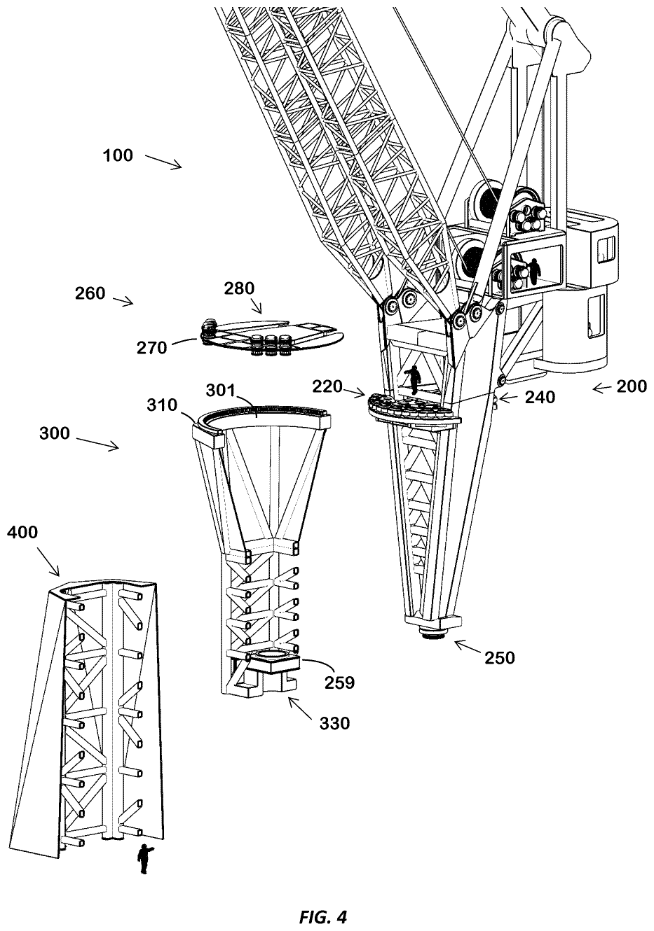

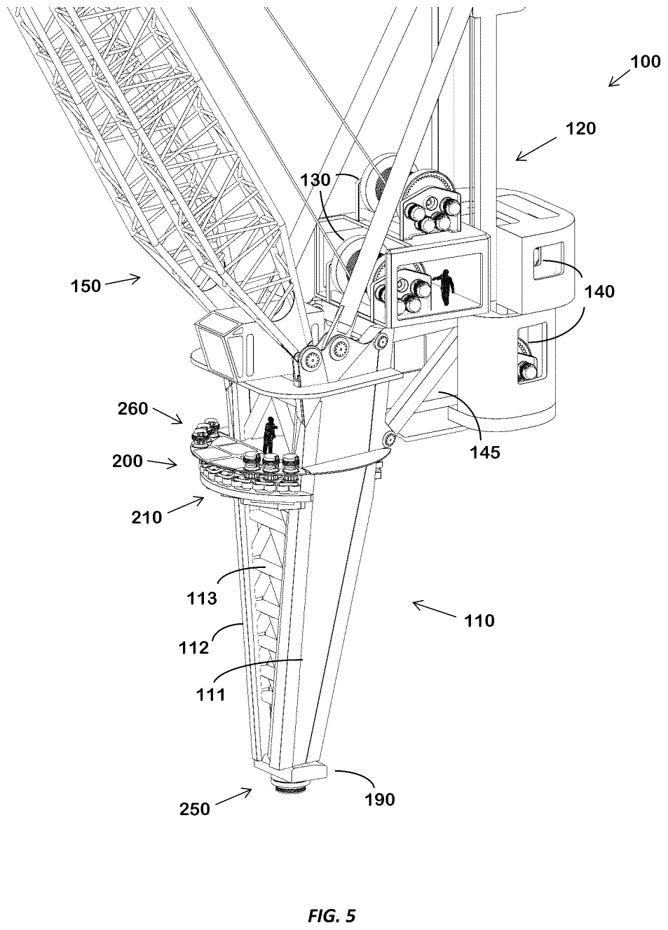

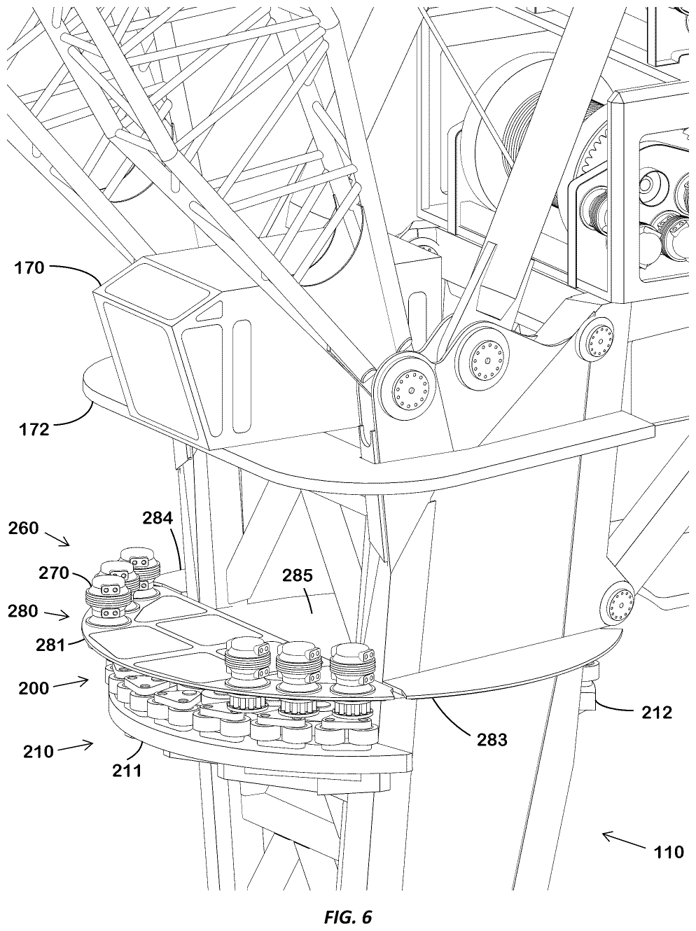

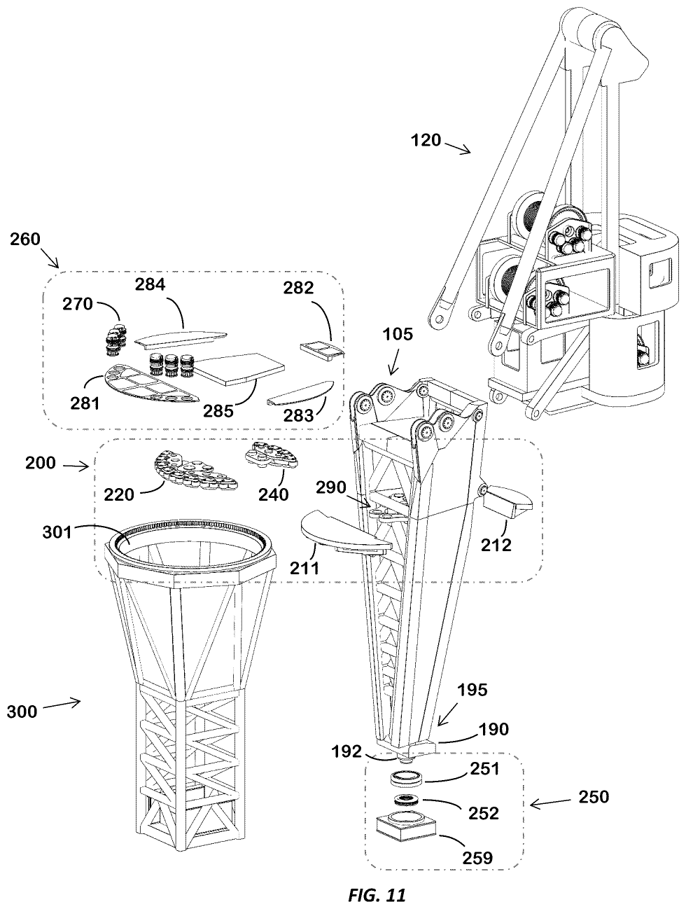

FIG. 4 is an upper 3D, partial section exploded view of the embodiment illustrated in FIG. 1. In this view, upper bearing assembly 200 is partially exploded to illustrate having a front upper bearing assembly 220 that operates in contact with an outer race 301 interior to a kingpost housing upper collar 310 of kingpost housing 300. Slew drive assembly 260 comprises a set of slew drives 270 mounted to a slew deck assembly 280. Access to front upper bearing assembly 220 and a rear upper bearing assembly 240, and slew drives 270 is provided through slew deck assembly 280 which may be comprised of multiple sections. In the embodiment illustrated, and as best seen in FIGS. 6, 11 and 12, slew deck assembly 280 is comprised of a set of slew deck sections 281, 282, 283, 284, and 285 which are mounted to a left side panel 111 or a right side panel 112 of a kingpost structure 110 (FIG. 5). Lower bearing assembly 250 is installed or assembled within a bearing box 259. Bearing box 259 is mounted in kingpost housing 300. Bearing box 259 may be a removable part as shown in FIG. 11 or it may be integral to kingpost housing 300.

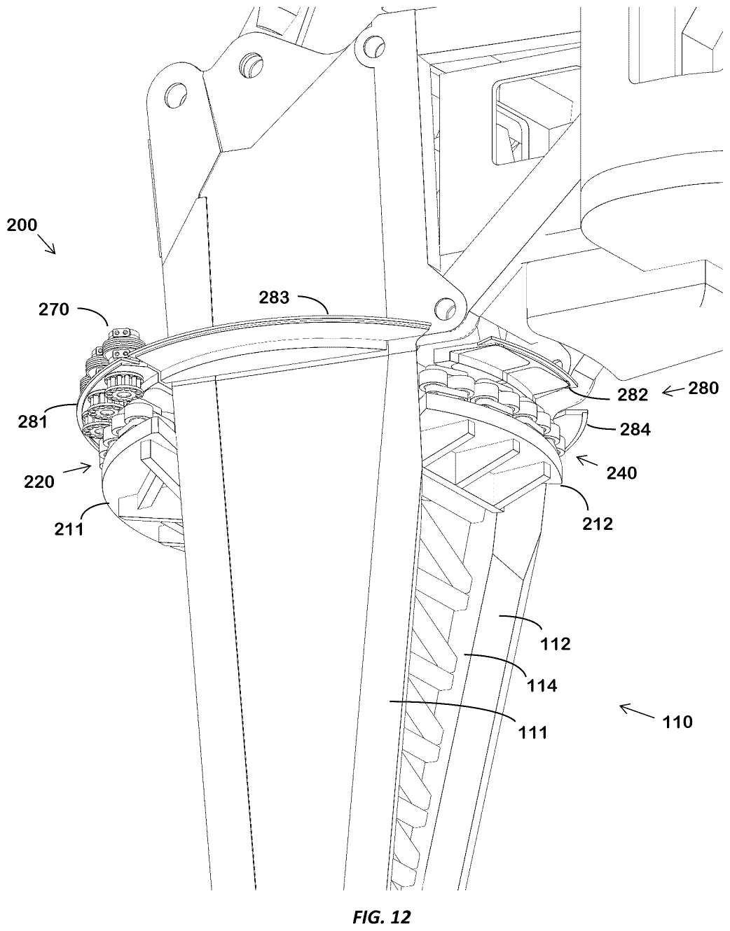

FIG. 5 is an upper 3D view of the embodiment illustrated in FIG. 1. As seen in this view, rotating kingpost assembly 100 comprises kingpost structure 110 which may be comprised of left side panel 111, right side panel 112, a front bracing 113 and a rear bracing 114 (FIG. 12). A lower bearing mount frame 190 is secured to the bottom of kingpost weldment 110. As best seen in FIG. 11, a lower bearing mount shaft 192 extends through and shoulders on surfaces of lower bearing assembly 250 (FIG. 4.)

Referring again to FIG. 5, rotating kingpost assembly 100 has a boom assembly 150 pivotally connected thereto. A gantry assembly 120 (inclusive of rigging) supports the distal end of boom 150, raising and lowering it with a single or set of boom luffing winches 140. A single or set of main hoisting winches 130 enable adjustment of the hook's height for any given boom position. A single or set of fluid or electric power unit(s) 145 (only unit space is shown) provide hydraulic or electric power to luffing winches 140, hoisting winches 130 and slew drives 270.

FIG. 6 is an upper 3D view of the embodiment illustrated in FIG. 1. As seen in FIG. 6, an operator cab 170 and an operator deck 172 are provided in a position of maximum visibility for operations. In the embodiment illustrated, slew deck assembly 280 is comprised of five slew decks or deck regions also shown in FIGS. 11 and 12; front slew deck 281, opposite rear slew deck 282, left slew deck 283, right slew deck 284, and central slew deck 285. Together, slew deck assembly 280 provides front to rear and circumferential structural slewing load transfer and distribution, as well as level structure for standing, observing and directing operations. It may also provide environmental containment and personnel access features from above for inspection or maintenance of upper bearing assembly 200. Below and supporting upper bearing assembly 200 is a bearing deck assembly 210 comprising at least a pair of bearing decks front 211 and rear 212 which can support and constrain upper bearing assemblies front 220 and rear 240 during different phases of installation, operation and repair.

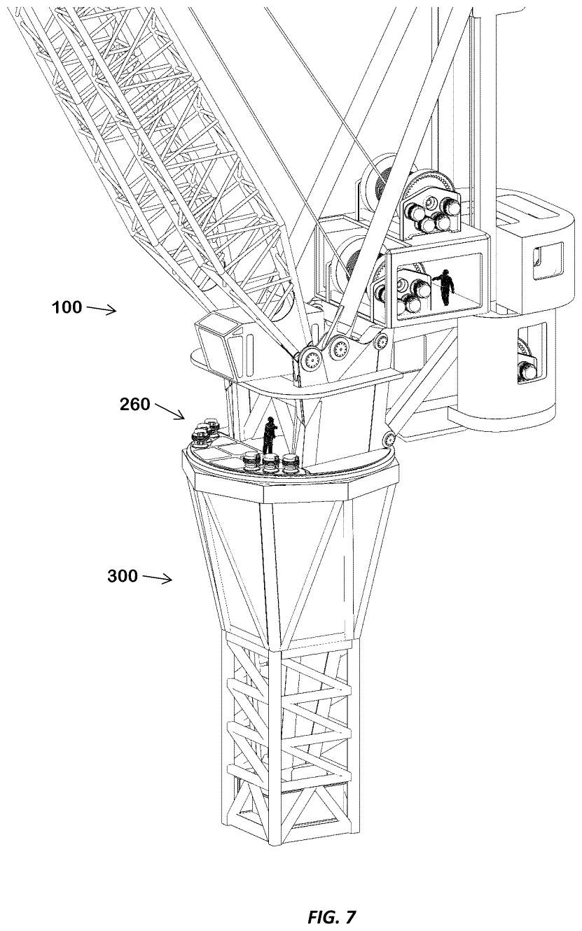

FIG. 7 is an upper 3D view of an alternate embodiment of the current invention. In this embodiment, kingpost housing 300 can be affixed directly to vessel hull 500 or other support structure.

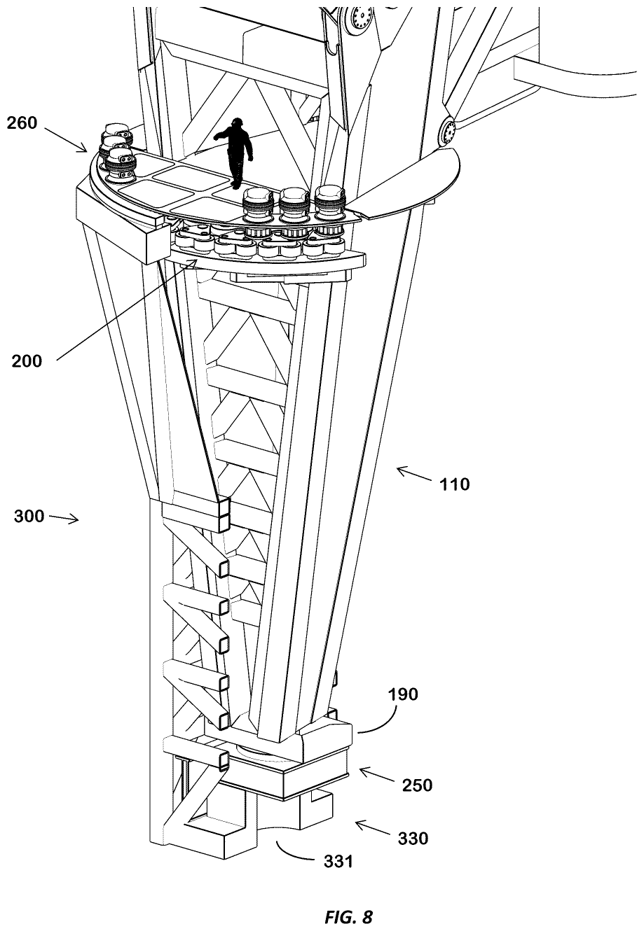

FIG. 8 is an upper 3D partial section view of the embodiment illustrated in FIG. 7 illustrating relationships between kingpost housing 300 and rotating kingpost structure 110, and between kingpost housing 300 and upper and lower bearing assemblies 200 and 250. It also illustrates a service line opening 331 within a kingpost housing bottom framing 330 primarily used for power and control lines communicating between crane 10 and vessel hull 500 and if large enough may be used for personnel access. Typically, a rotatable service line swivel is also required at this location.

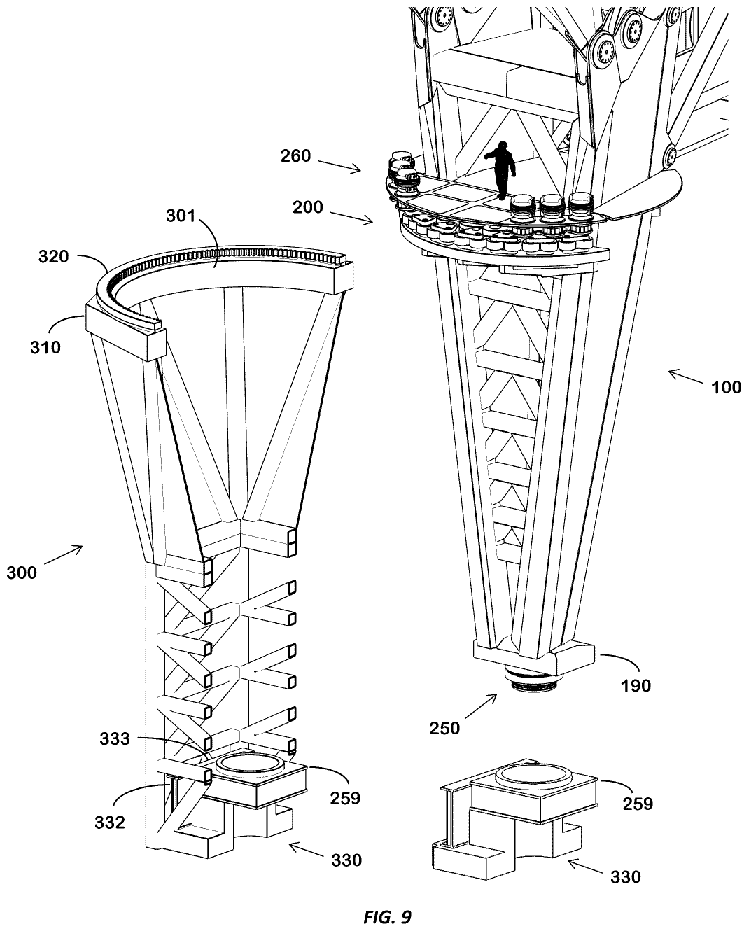

FIG. 9 is an upper 3D partial section view of the embodiment illustrated in FIG. 7 showing more details of upper bearing assembly 200 and outer race 301, as well as slew drive assembly 260 mating with a slew gear ring 320. In this view, kingpost housing 300 is depicted with lower bearing assembly 250 installed on lower bearing frame 190. These bearings can be first mounted within bearing box 259 configured on stationary kingpost housing bottom structure 330 prior to completing installation and assembly. Note that a set of kingpost housing jacking beams 332 support jacks placed between a set of beam surfaces 333 and kingpost lower bearing frame 190 to separate and lift rotating kingpost crane assembly 100 (with the boom safely in the rest) in order to facilitate installation, inspection and maintenance of lower bearing assembly 250. Kingpost housing bottom structure 330 can be configured independently to mount directly onto vessel hull 500, or onto pedestal base 400 which may be configured to mount to vessel hull 500 or another support structure. Kingpost housing bottom structure 330 is shown duplicated below the rotating kingpost to clarify its mounting independence for optimizing load transfer to the hull or for accommodating a wider pedestal base.

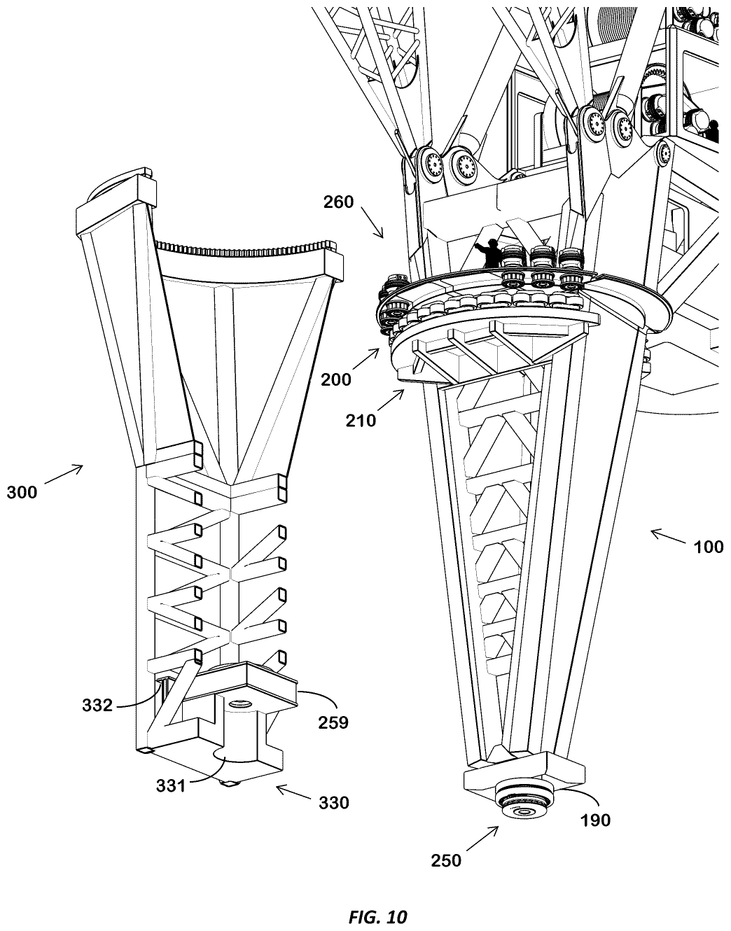

FIG. 10 is a lower 3D partial section view of the embodiment illustrated in FIG. 7 showing the same parts as FIG. 9 but from below for added clarity. In this view, service line opening 331 is visible below bearing box 259.

FIG. 11 is an upper 3D partial section exploded view of the embodiment illustrated in FIG. 7 hiding boom assembly 150 for clarity, showing kingpost structure 110, gantry assembly 120, kingpost housing 300, and primarily the breakdown of upper bearing assembly 200 comprising upper bearing assembly front 220 and upper bearing assembly rear 240, upper bearing outer race 301, and upper bearing decks front 211 and rear 212. Also shown is the upper end (105) and lower end (195) of the rotating kingpost (110).

Referring again to FIG. 11, lower bearing assembly 250 is shown comprising a radial bearing 251 and a thrust bearing 252 that may be mounted either on lower bearing shaft 192 (extending from lower bearing frame 190) or in lower bearing housing box 259. Slew drive assembly 260 is shown comprising slew drive motor and roller pinion sets 270 and slew drive deck assembly 280 comprising five deck sections: front 281, rear 282, left 283, right 284, and center 285. Some sections of deck 280 may be fitted with hatches for access to upper bearing assembly 200 below.

FIG. 12 is a lower 3D view of the embodiment illustrated in FIG. 7 showing more details of kingpost weldment 110 comprising side panels 111, 112, front bracing 113 (not visible in this view), and rear bracing 114. Slew drive deck assembly 280 comprises decks front 281, rear 282, left 283, right 284, and center 285, and upper bearing support deck assembly 210 beneath comprises at least decks front 211 and rear 212, and possibly left and right side decks (not shown).

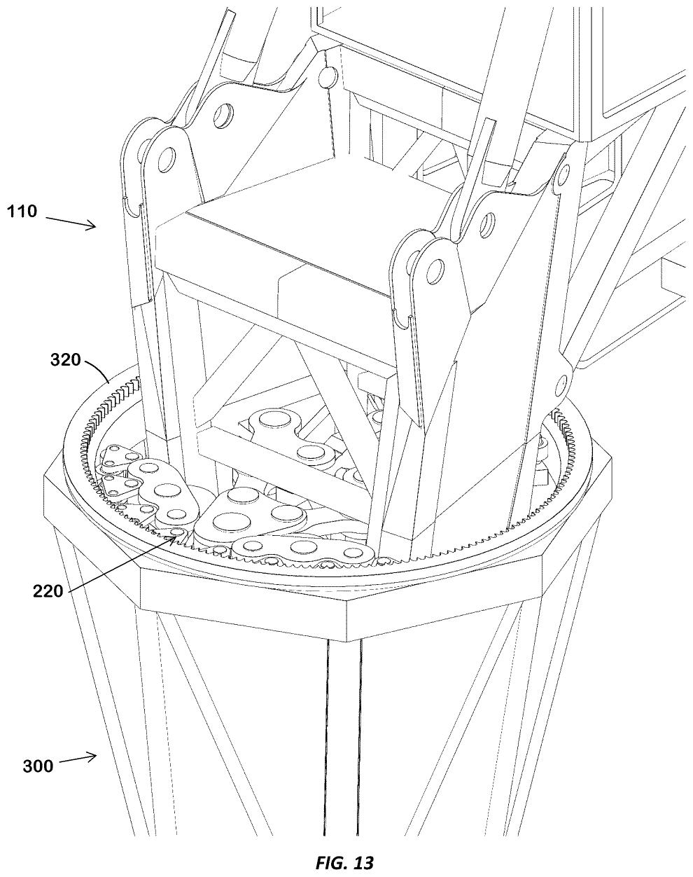

FIG. 13 is an upper 3D view of the embodiment illustrated in FIG. 7 with boom 150, slew drive assembly 260, and slew deck assembly 280 removed to more clearly show the relative positions of slew gear 320 and many of the spreader components of upper bearing segment assembly front 220.

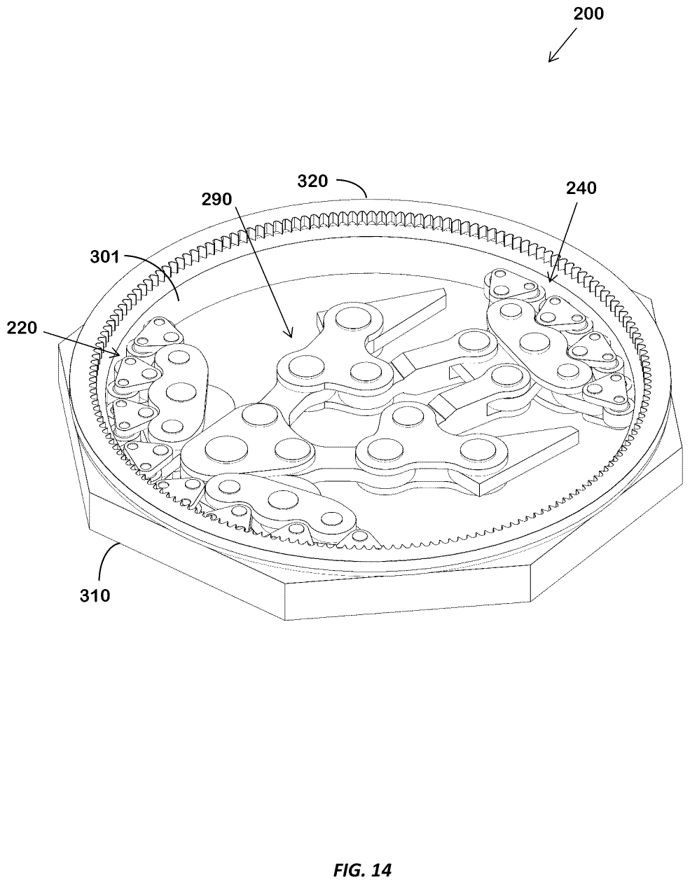

FIG. 14 is an upper 3D view of the embodiment illustrated in FIG. 7 showing only upper bearing segment assemblies front 220 and rear 240 and their bearing linkage mechanism 290 between them, with 220 and 240 in contact with bearing outer race 301 within kingpost housing upper collar 310, also showing slew gear 320 just above upper bearing segments front 220 and rear 240.

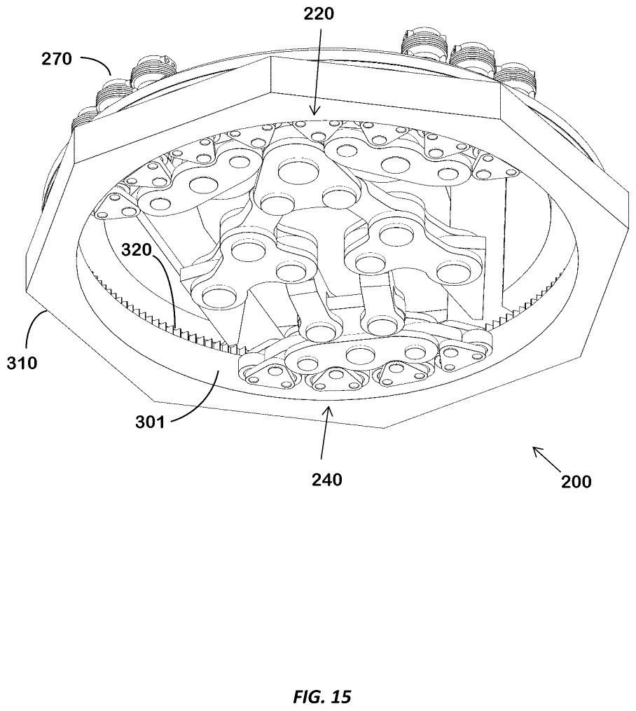

FIG. 15 is a lower 3D view of the embodiment illustrated in FIG. 7 showing the same components as FIG. 14, except they are viewed from beneath.

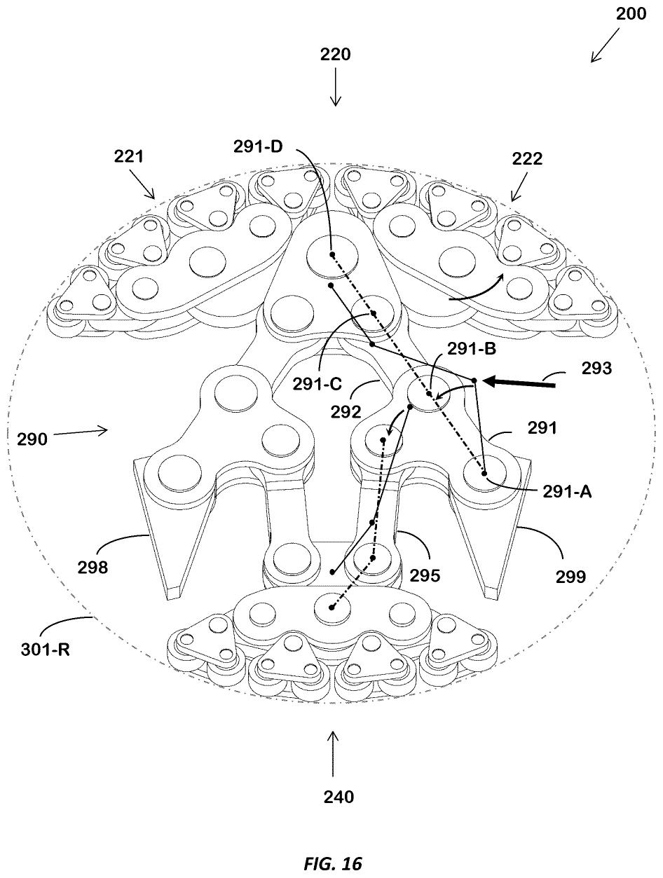

FIG. 16 is an upper 3D view of the embodiment illustrated in FIG. 7 showing only upper bearing segment assemblies front 220 and rear 240 and an upper bearing linkage mechanism 290 between them, in the preloaded, extended configuration for operations, with all of its components including two linkage mechanism linkage anchor lugs, a left 298 and a right 299, connected to the insides of kingpost weldment 110. Note a set of four (4) pin positions 291-A, B, C, and D that align with a toggle link 292 on the dashed straight line, and three (3) pins that align on the upper segment of the crooked dashed line with a toggle link 295. In this configuration, all bearing rollers, front and rear, are in preloaded contact with upper bearing race 301 at a reference surface 301-R.

FIG. 16 also shows an arrow 293 representing the force direction of a linear actuator (not shown), such as a screw-jack or hydraulic cylinder, used to rotate a drive link 291 about its pivot point, pivot pin position 291-A, into this “locked” state. Linkage mechanism pin positions 291-A, B and C form a toggle sub-mechanism that provides locking in the straight-line configuration shown. In this Figure, rotating only two mirror-symmetrical left and right drive links 291 of drive link mechanism 290 preloads both upper bearing assemblies front 220 and rear 240. Note also that all upper bearing linkage mechanism details and parts described on the right side of the crane are symmetrical with and operate the same as those on the left side.

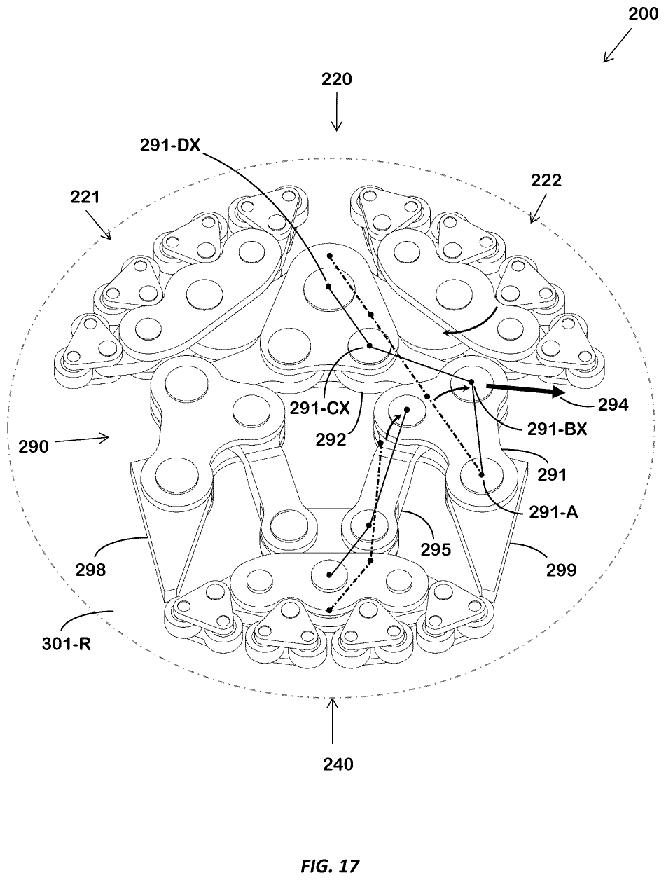

FIG. 17 is an upper 3D view of the embodiment illustrated in FIG. 7 showing only upper bearing segment assemblies front 220 and rear 240 and upper bearing linkage mechanism 290 between them, in the clearance, retracted configuration for maintenance, with all of its components including two linkage anchor lugs 298, 299 connected to the insides of kingpost weldment 110. In this configuration, comparing to FIG. 16, a set of pin positions 291-BX, CX and DX have departed from the dashed straight line. The only pin position remaining on either dashed line is drive link pivot pin position 291-A on kingpost anchor lug 299 and all bearing rollers, front and rear, are not in contact with upper bearing race 301 at reference surface 301-R, creating a gap all around. This gapped configuration can be used to facilitate installation and repairs.

FIG. 17 also shows a force vector arrow 294 representing the force direction of a linear actuator such as a screw-jack or hydraulic cylinder, used to rotate drive link 291 about its pivot pin position 291-A into this “relaxed” state. Linkage mechanism pin positions 291-A, B and C form a toggle sub-mechanism that provides unlocking once the straight-line configuration is deviated as shown. In this Figure, drive link 291 releases both upper bearing assemblies front 220 and rear 240.

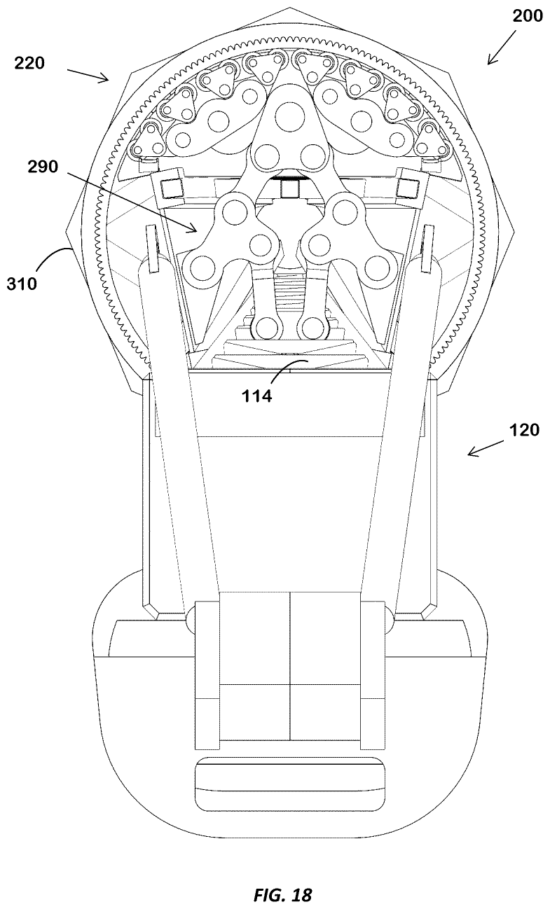

FIG. 18 is an upper plan partial section view of the embodiment illustrated in FIG. 7 showing some of crane 20 without boom assembly, slew drives and decks, to highlight upper bearing front and rear segment assemblies 220 and 240 and bearing linkage mechanism 290 between them and their component positions relative to kingpost structure 110. Note that horizontally oriented upper bearing assembly 200 intersects the envelope of substantially vertically oriented, kingpost structure 110, and is designed with bracings front 113 and rear 114, versus a closed kingpost section, as one way to allow space for upper bearing linkage mechanism 290 and kingpost structure 110 to coexist and function in the same space.

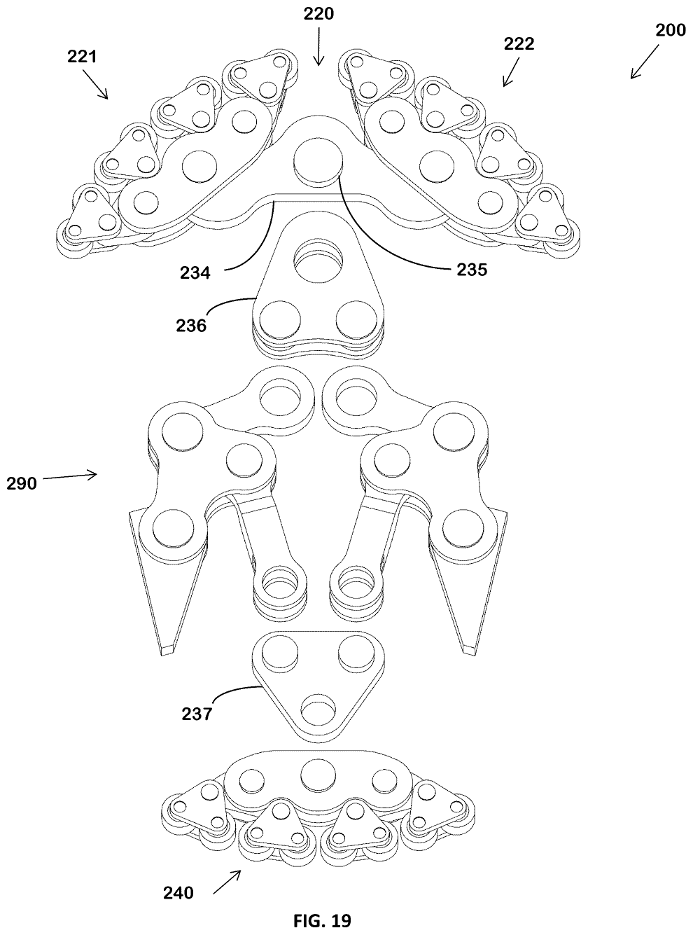

FIG. 19 is an upper 3D exploded view of the embodiment illustrated in FIG. 7 showing only upper bearing assemblies front 220 and rear 240 and upper bearing linkage mechanism 290 components between them. Upper bearing front assembly 220 includes a left side 221 and a right side 222, which may be identical in structure to rear assembly 240. A linkage adapter front 236 and a linkage adapter rear 237 help space and equalize left and right loading while accommodating the front bearings' idealized, straight-line loading from kingpost structure 110 at lugs 239 (see FIG. 16) to front upper bearing assembly 220 via a level 4 spreader 234 at a spreader pin 235.

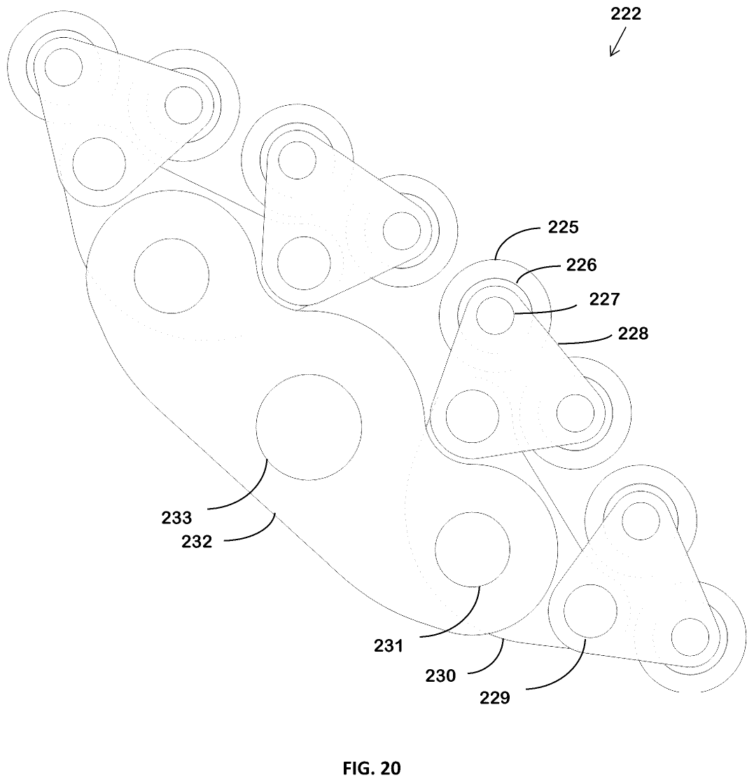

FIG. 20 is an upper plan view of the embodiment illustrated in FIG. 7 showing only a set of roller shoes 228, and a set of spreaders 230 and a set of spreaders 232. Roller shoes 228 and spreaders 230 and 232 are interconnected to achieve load equalization in the following way: a set of bearing rollers 225 are each mounted, preferably in pairs, on a set of roller bushings 226, each mounted on a set of roller pins 227, and extending through one end of roller shoes 228 having a set of pivot pins 229 extending through spreaders 230 having a set of pivot pins 231 extending through spreaders 232 having a set of pivot pins 233 interconnected to bearing linkage mechanism 290.

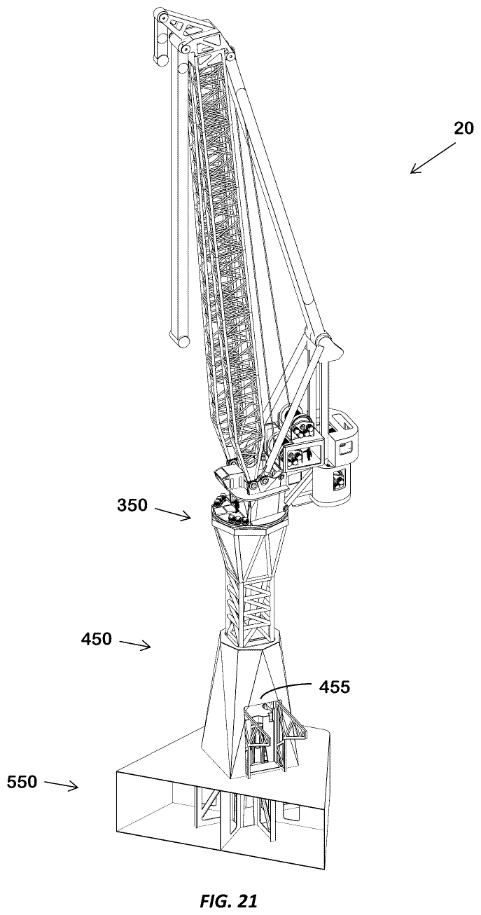

FIG. 21 is an upper 3D view of an alternate embodiment of the present invention as an offshore tower crane 20 having a segmented, extensible mast by adding mast length under a kingpost housing 350 with a connectable set of mast extension(s) 351 fed through a pedestal base 450 with a pedestal opening 455 shown at the deck level of vessel hull 550.

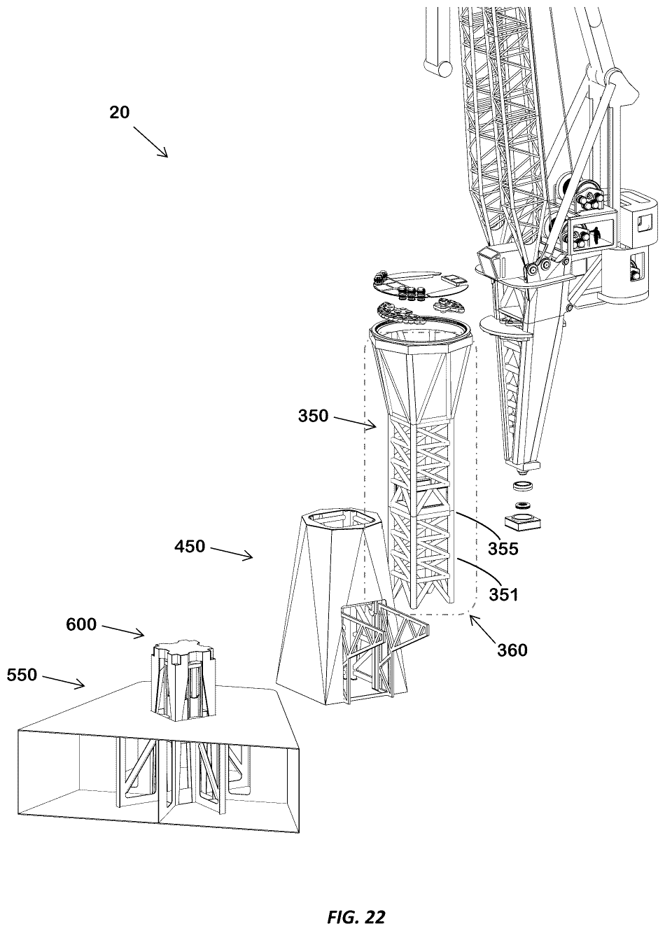

FIG. 22 is an upper 3D exploded view of the embodiment illustrated in FIG. 21 showing offshore tower crane 20 with a mast assembly 360 comprising kingpost housing 350 atop and interconnected by a mast connector 355 to mast extension 351 within and mechanically connected to pedestal base 450 and this affixed to vessel hull 550 or other support structure having a jacking elevator 600 for lengthening mast assembly 360 with mast extension(s) 351.

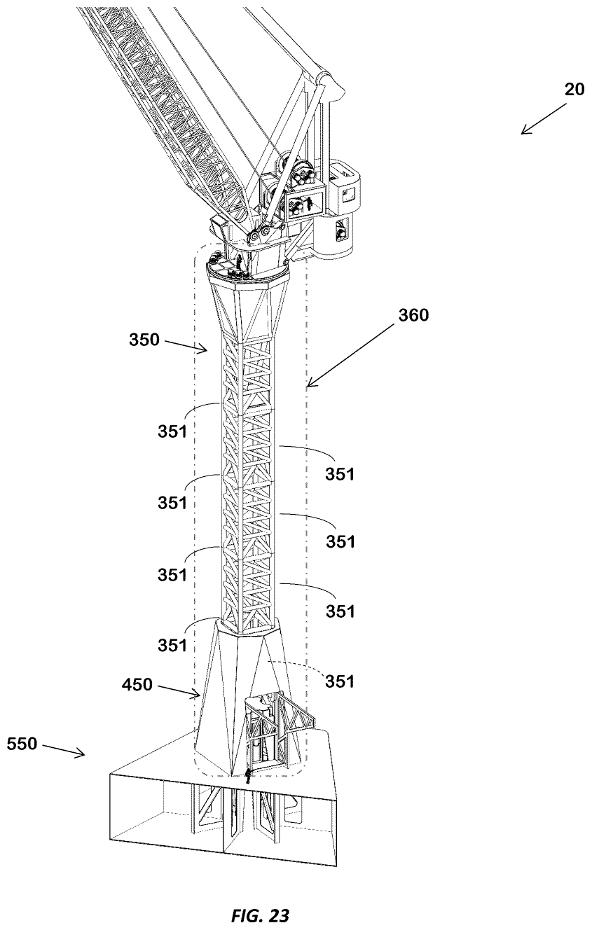

FIG. 23 is an upper 3D view of the embodiment illustrated in FIG. 21 showing the offshore tower crane 20 with its mast 360 comprising kingpost 350 atop and interconnected by mast connectors 355 to four mast extensions 351, one of these being mostly hidden behind pedestal base 450.

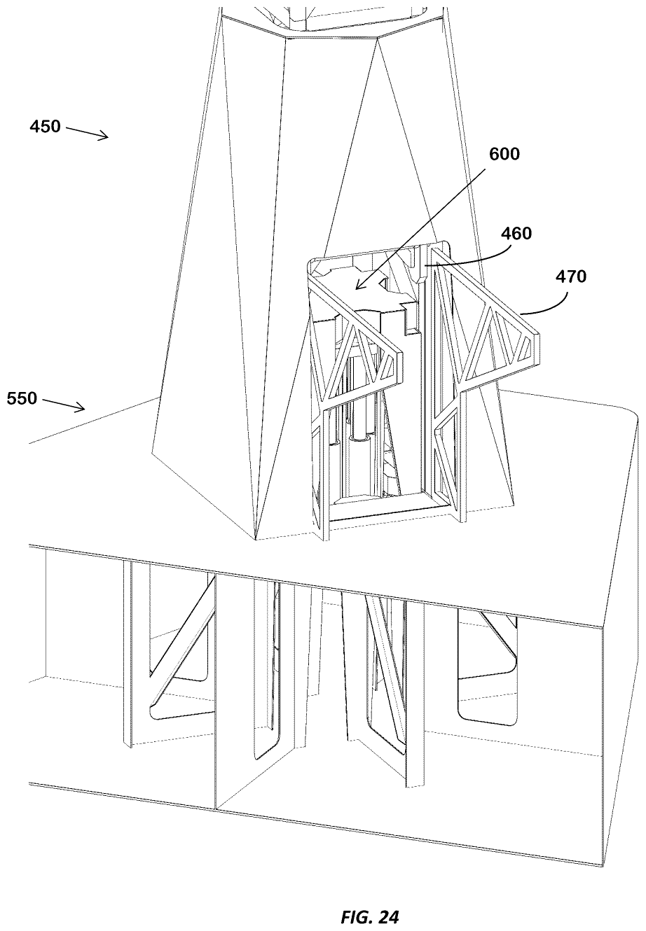

FIG. 24 is an upper 3D view of the embodiment illustrated in FIG. 21 showing pedestal base 450 of offshore tower crane 20 and mast jacking elevator 600 embedded within vessel hull 550 allowing 600 to retract below the deck of vessel hull 550. An overhead crane 470 is located at pedestal base opening 455 which can be reached by crane 20 for self-erection of tower crane's mast assembly 360 to an appropriate height. A set of two or more mast latches 460 articulate on the inside of pedestal base 450 to support tower crane's 20 weight when not on the mast jacking system 600. As in typical vertical jacking systems, such as mobile jack-up barges (MODU's), both jacking elevator 600 and mast extension 351 being jacked are located and guided to align vertically inside of both pedestal base 450 and vessel hull 550 by internal surfaces integral to both 450 and 550 (not shown here.)

Referring again to FIGS. 23 and 24, after each mast extension section 351 is set inside pedestal base 450, slightly raised and attached at connectors 355, jacked up mast latches 460 are deployed to support the vertical weight and incidental moments (calm seas) as mast jacking system 600 is retracted and recycled to receive another mast extension 351 for extending the height of mast assembly 360. Finally, bottom-most mast extension 351 (not shown) is not necessarily jacked up and latched; it can be simply elevated slightly and connected to the mast remaining at this lowest position on the mostly retracted jacking elevator 600 as this can help to stiffen and increase tower crane's 20 moment capacity.

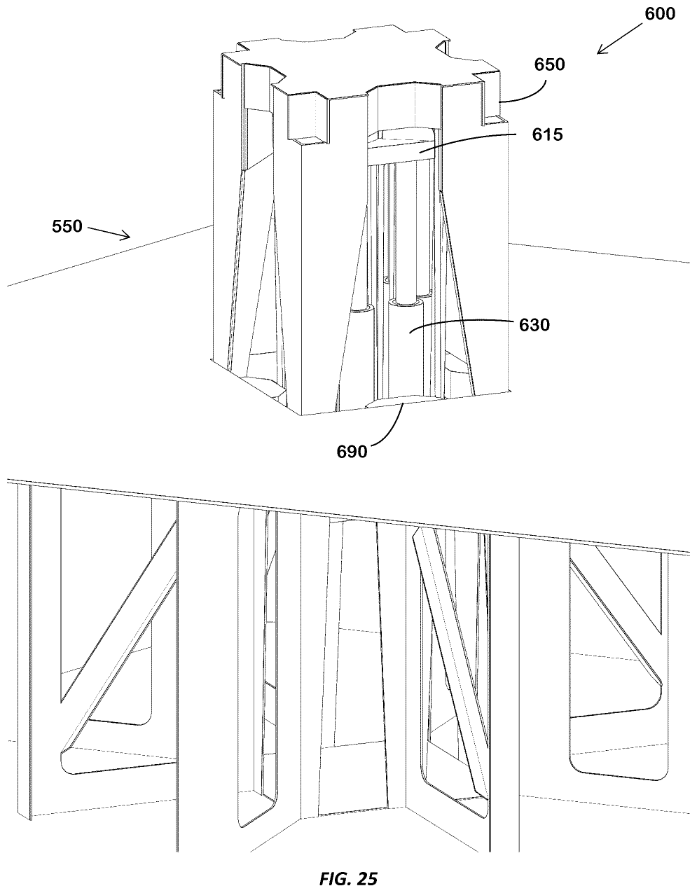

FIG. 25 is an upper 3D view of the embodiment illustrated in FIG. 21 showing the mast jacking elevator 600 extended up above the vessel hull 550. A set of corner notches 650 are used for clearance of latches 460 during load transfer from jacking system 600 to pedestal base 450. A set of anchor lugs 690 attached to the deck of vessel hull 550 allow a set of hydraulic cylinders 630 which extend and retract, and an elevator frame 610 connected to a yoke frame 615 to redistribute lengths of wire rope interconnecting these components with sheaves (not shown) for raising and lowering assembly 600.

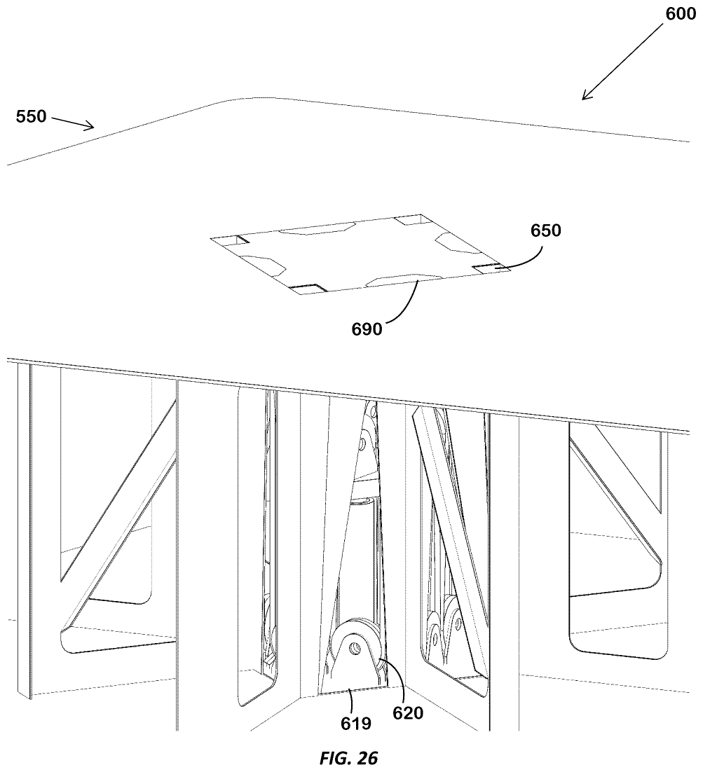

FIG. 26 is an upper 3D view of the embodiment illustrated in FIG. 21 showing only tower jacking elevator 600 retracted down into vessel hull 550, exposing a set of elevator sheaves 620 and a set of sheave anchor lugs 619.

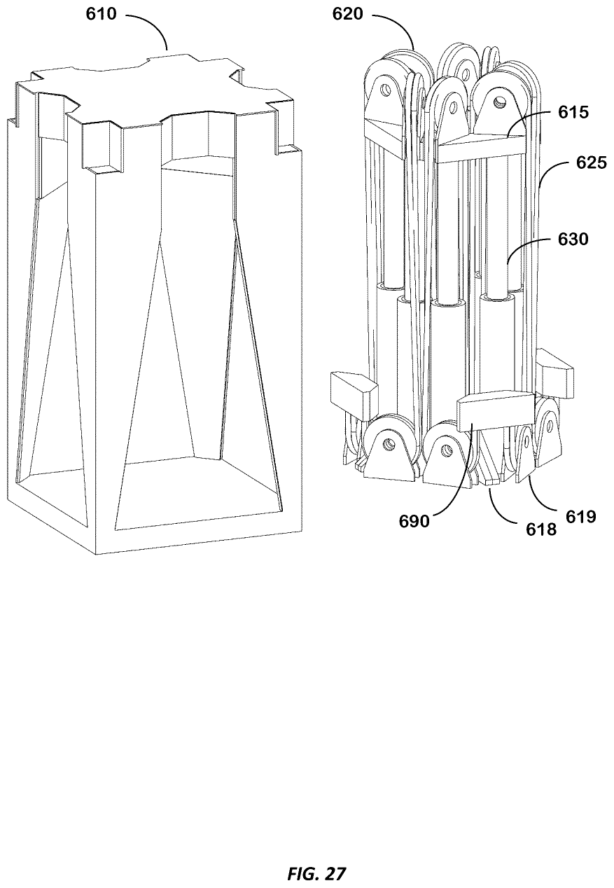

FIG. 27 is an upper 3D exploded view of the embodiment illustrated in FIG. 21 showing the primary elements of mast jacking elevator 600 comprising outer frame 610, sheaves 620, a set of wire ropes 625, hydraulic cylinders 630, yoke frames 615, a set of rope anchors 618 (to elevator frame 610), sheave anchor lugs 619 (to elevator frame 610), and rope anchor 690 (to vessel hull 550 structure).

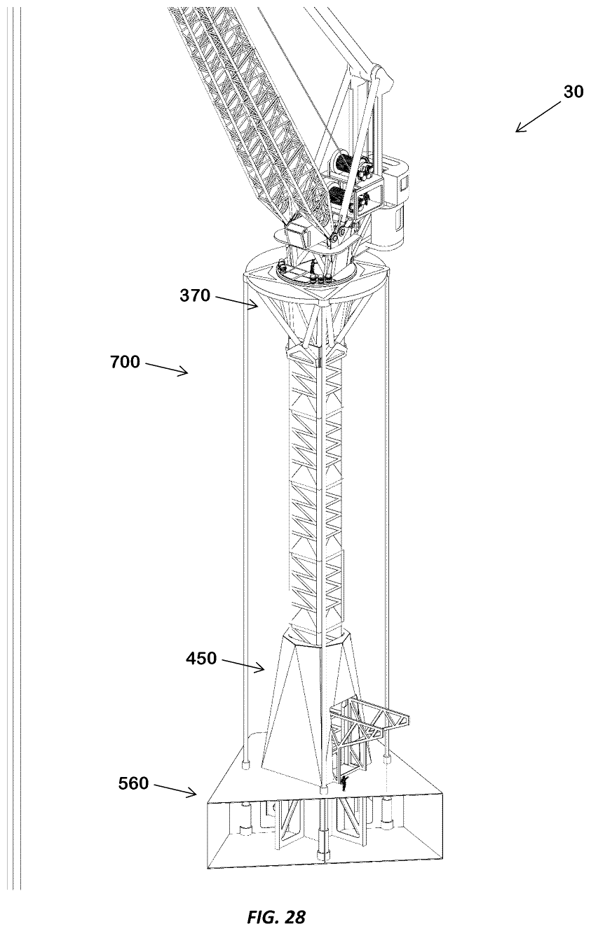

FIG. 28 is an upper 3D view of an alternate embodiment of the present invention showing a tendon-stiffened offshore tower crane 30 with an active moment compensation system (AMC) 700 embedded into a vessel hull 560 for stability at top of the mast where added outrigger features upgrade a kingpost housing 370 for tendon loading.

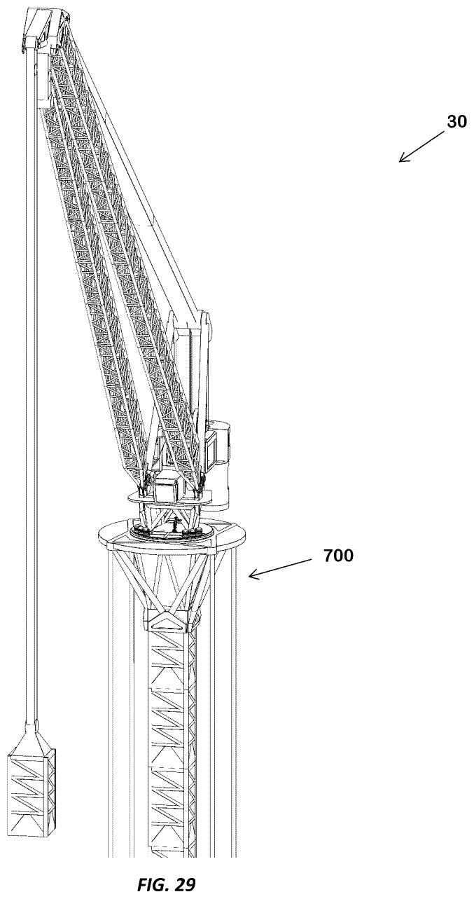

FIG. 29 is an upper 3D view of the embodiment illustrated in FIG. 28 more clearly showing AMC 700 having four tendons, which could also be six or more tendons depending on mast height, moment and sea-state loading.

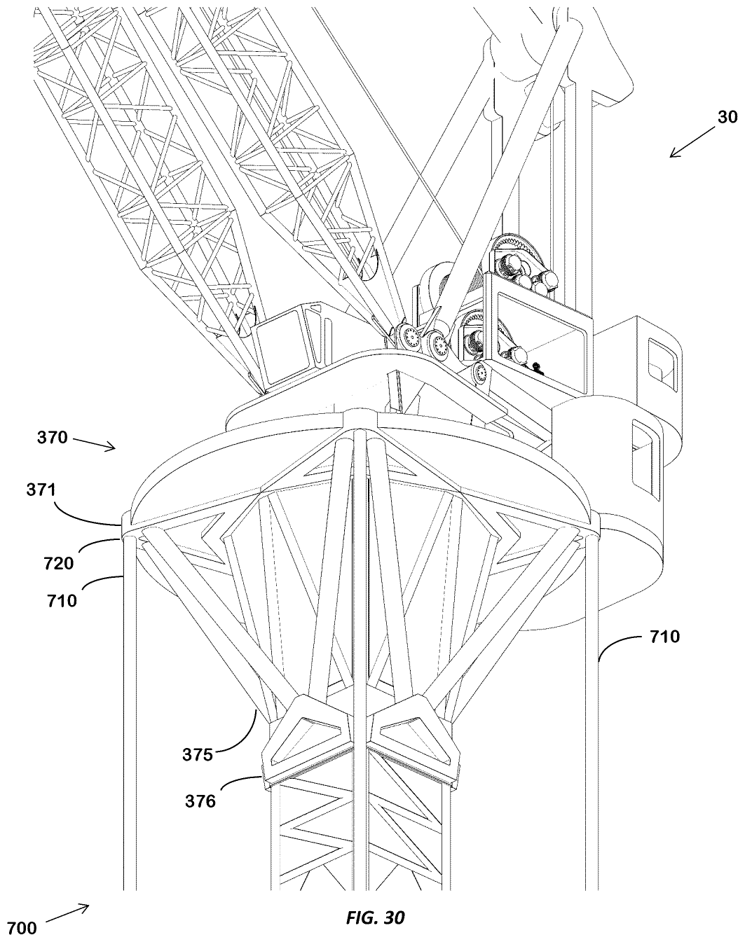

FIG. 30 is a lower 3D view of the embodiment illustrated in FIG. 28 more clearly showing kingpost housing 370 upgraded for a set of tendons 710 attached at a set of connectors 720 to a set of outriggers 371 (a structural feature), with a set of outrigger bracing 375 and an outrigger yoke 376 features for load transfer and stability.

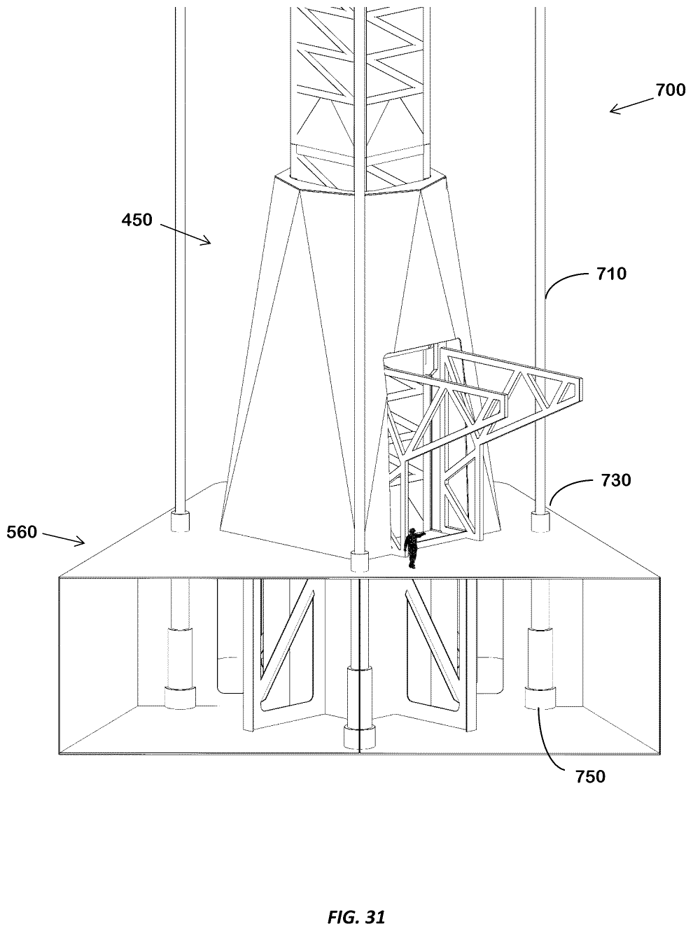

FIG. 31 is an upper 3D view of the embodiment illustrated in FIG. 28 more clearly showing the active moment compensation (AMC) 700 with tendons 710 connected at a set of tensioner connectors 730 to a set of tendon tensioners 750. AMC 700 operates similar to an active motion compensation system (usually having the same acronym, “AMC”); however, instead of actively compensating for a vessel's motion or movement in the sea, this system 700 actively compensates for the crane's overturning moment, experienced at outriggers 371 and all the way down crane mast assembly 360 as bending deflections cause the highest rotations and translations near outrigger 371 elevation. Such overturning moments and deflections are common for most tower cranes, but can be excessive for offshore tower crane 30. Though land tower cranes use counterweight (CW) to offset the overturning moment, offshore cranes cannot usually afford the weight or space for CW. As such, AMC system 700 uses preloaded and variable tension on tendons 710 to oppose the overturning moment's bending deflections. By sensing tension forces and interfacing with the crane's load-moment control system, which is common crane control equipment, AMC system 700 can actively compensate for these moment loads by increasing or decreasing tension to create an opposing moment as loads are lifted and released.

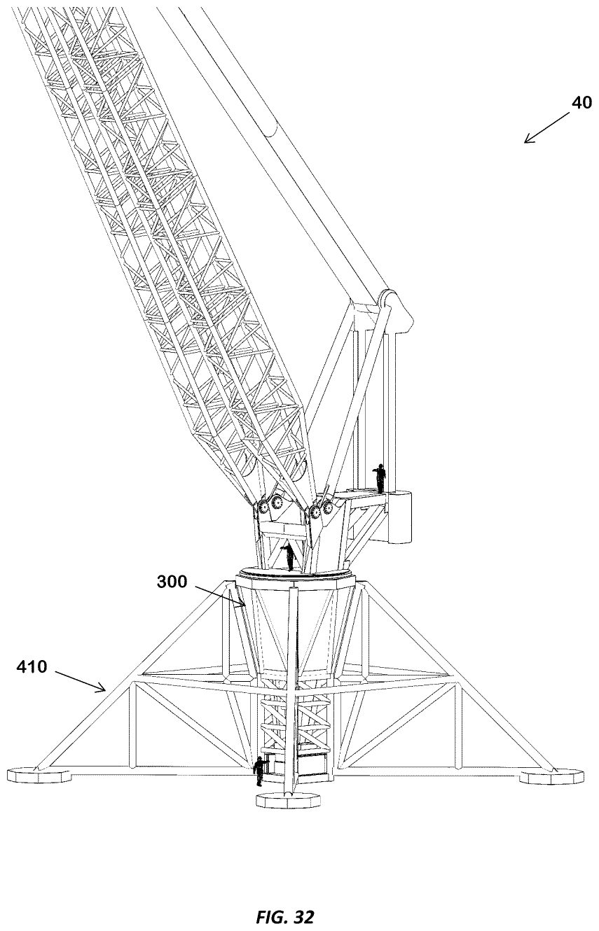

FIG. 32 is an upper 3D view of an alternate embodiment of the present invention showing a portable, land crane 40 application with kingpost housing 300 (used in other embodiments) set within a set of outriggers 410 configured to securely connect and support all loading.

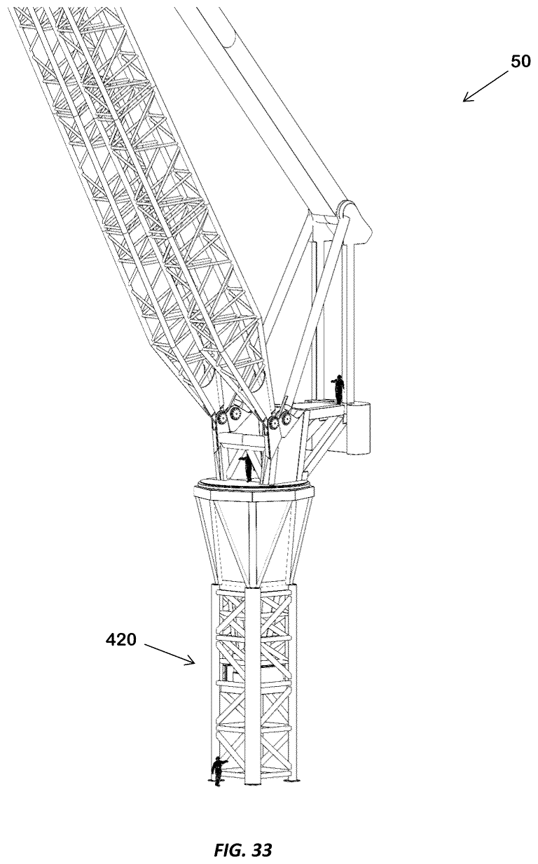

FIG. 33 is an upper 3D view of an alternate embodiment of the present invention showing the upper portion of a seaport gantry crane 50 to be fitted to the lower traveling portion of it (not shown), by connection to a gantry crane pedestal base 420.

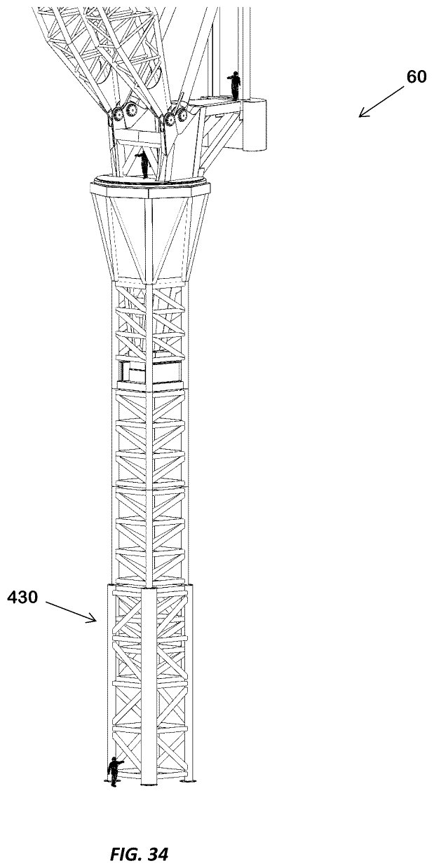

FIG. 34 is an upper 3D view of an alternate embodiment of the present invention showing a land tower crane 60 with a pedestal base 430 to be set into an underground foundation with space and handling means designed similar to offshore tower crane configuration 20 or 30 depending on mast assembly 360 height and use of an AMC system 700. Land tower crane 60 can also be assembled with pedestal base 430 configured for an outrigger system similar to outrigger 410 for use as a portable, land tower crane with self-erecting/jacking features substantially above grade.

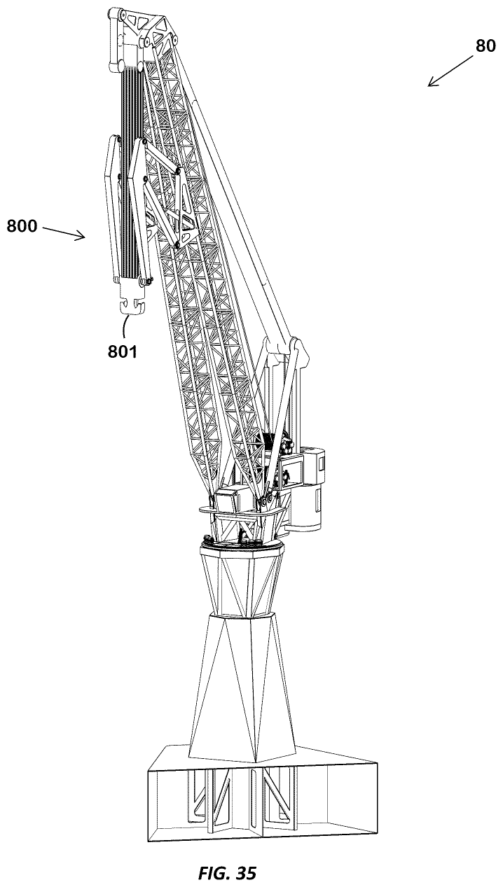

FIG. 35 is an upper 3D view of an alternate embodiment of the present invention showing an offshore crane 80 fitted with a block guidance system 800 which functions to latch onto a hook block 801 allowing it to be raised with the load as the extending mechanism rides up and down, under boom 150, the system passively allowing only equal extension or retraction of each side of the mechanism, effectively constraining sideways block swing and damping front-back swing.

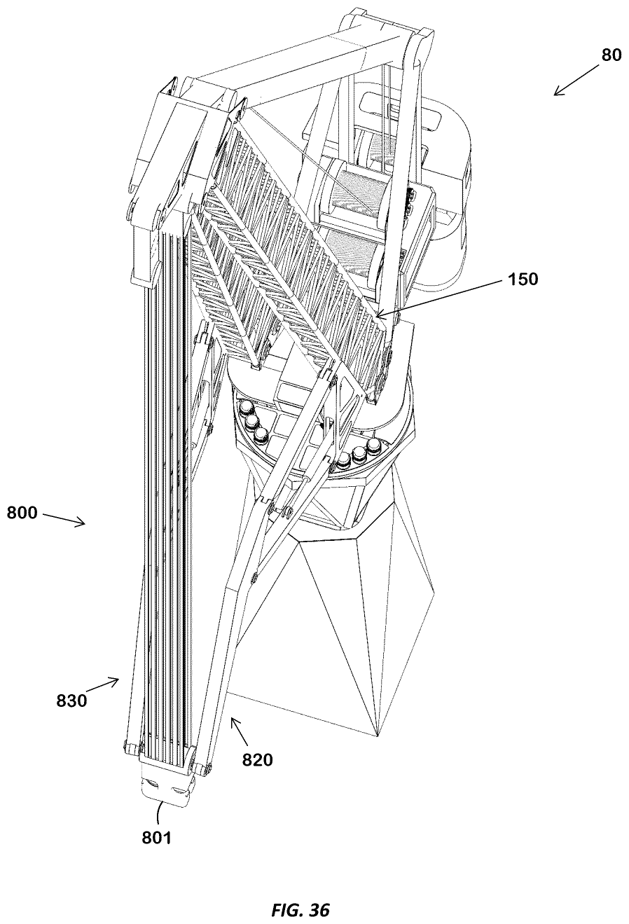

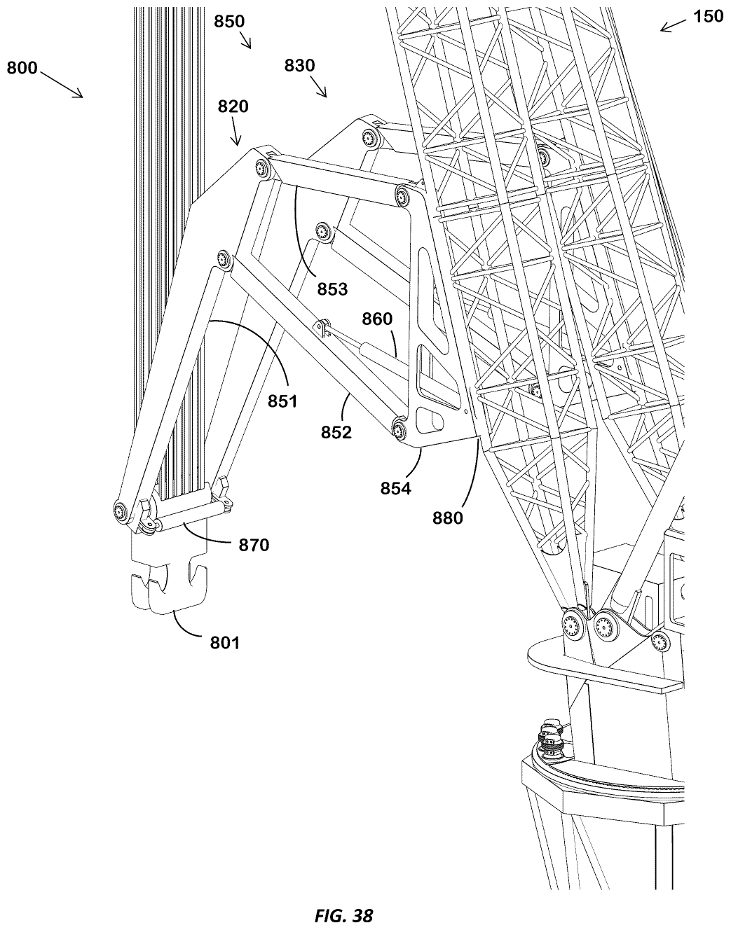

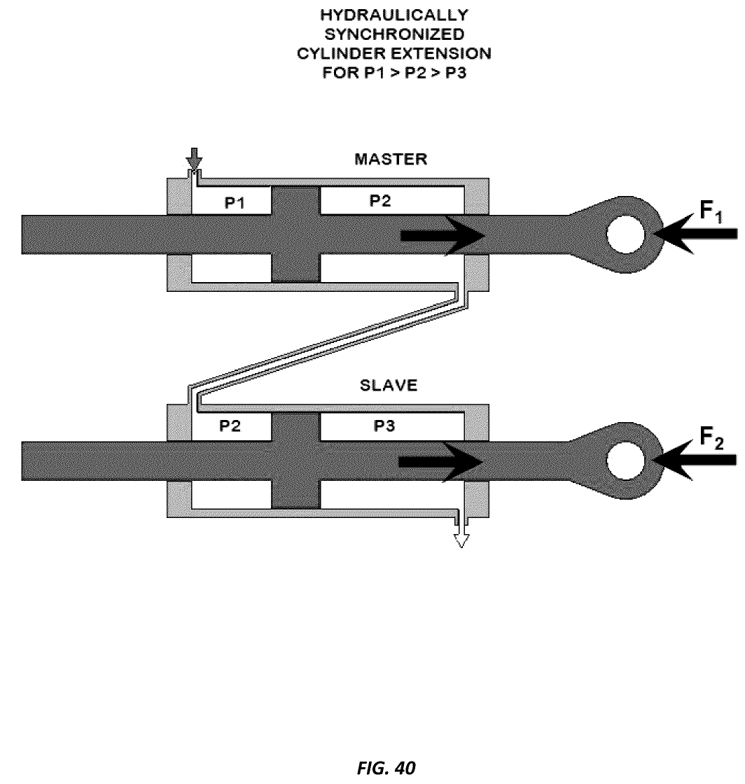

FIG. 36 is an upper 3D view of the embodiment illustrated in FIG. 35 showing block guidance system 800 at the crane deck elevation with both a left side linkage 820 and a right side linkage 830 of an extending mechanism 850 (FIG. 38) functioning under master-slave control (per FIG. 40) to extend or retract by equal amounts maintaining centered (symmetrical) alignment with boom assembly 150 as they ride up and down it, supported and moved by hook block 801.

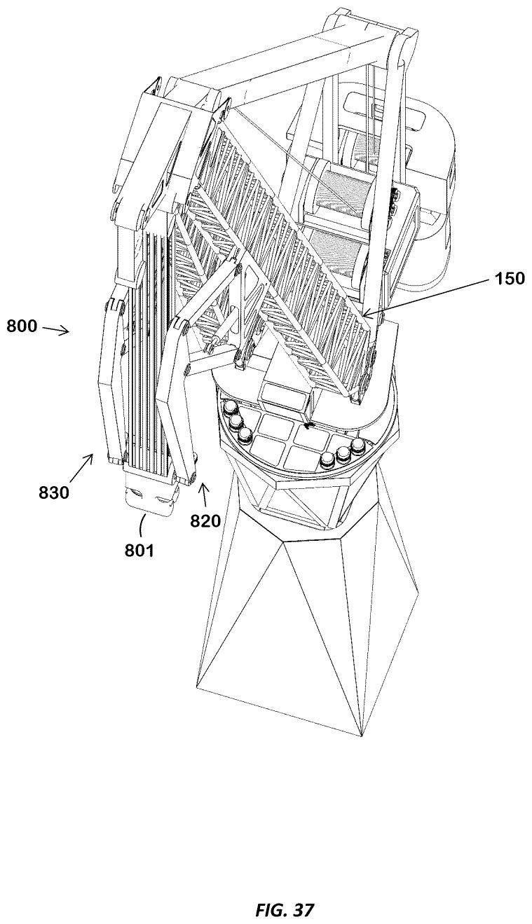

FIG. 37 is an upper 3D view of the embodiment illustrated in FIG. 35 showing block guidance system 800 at the highest block elevation.

FIG. 38 is an upper 3D view of the embodiment illustrated in FIG. 35 showing a side view of the block guidance system 800 comprising level extend mechanism 850 having symmetric 4-bar linkages left 820 and right 830 each comprising a guide arm 851 rotatably coupled to both a drive link 852 and a follower link 853, both of these rotatably coupled to a pair of truck base links 854. An extend cylinder 860 is connected between drive link 852 (as shown) or guide arm 851 and base link 854. When system 800 is near the lowest elevation, a set of block latching pins 875 (hidden here, see FIG. 40) are engaged, ready for block guiding as the system is hoisted by hook block 801.

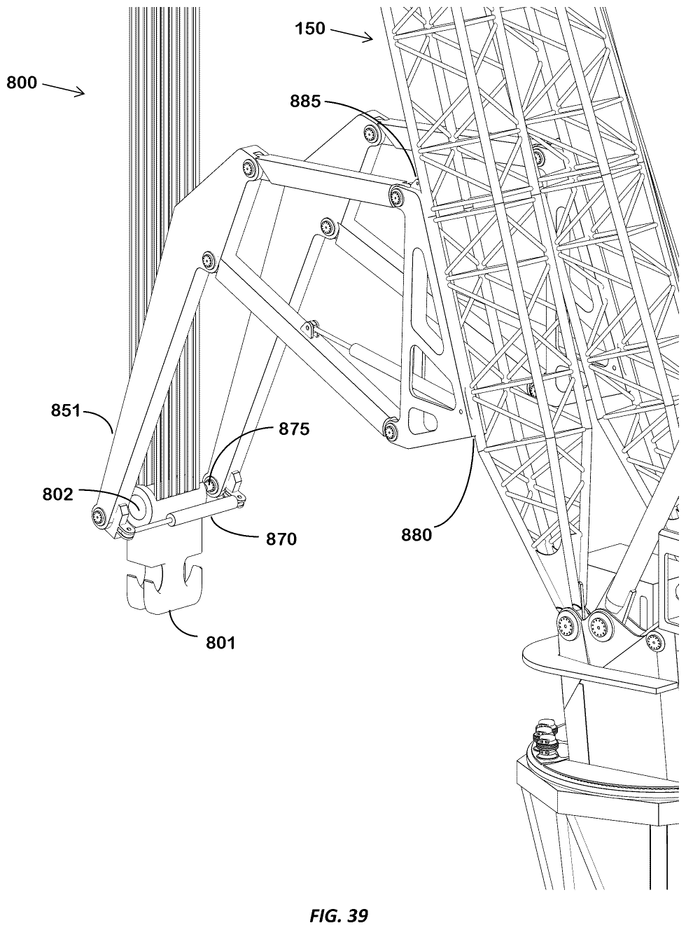

FIG. 39 is an upper 3D view of the embodiment illustrated in FIG. 35 showing a side view of block guidance system 800 near the lowest elevation with block latching pins 875 released from a set of block receptacles 802 by a latching actuator 870. Two truck base links 854 left and right ride up and down the boom lower chord on tracks or rails (not shown) located at a position 880 below the lower chords of boom 150. A small winch (not shown) is attached at a pair lifting lugs 885 and operated to locate truck base links 854 along boom 150 to align near level with block 801 for attaching latching pins 875 to it. The hoist is configured to have controls to enable a light, constant tension mode required when truck base links 854 are being moved by block 801 being hoisted up or down.

FIG. 40 is an upper schematic of the embodiment illustrated in FIG. 35 showing the master-slave control arrangement selected to synchronize extension or retraction of the two, vertically oriented 4-bar linkage extend mechanisms, left 820 and right 830, allowing for a passive, auto-synchronizing feature versus a powered/controlled one.

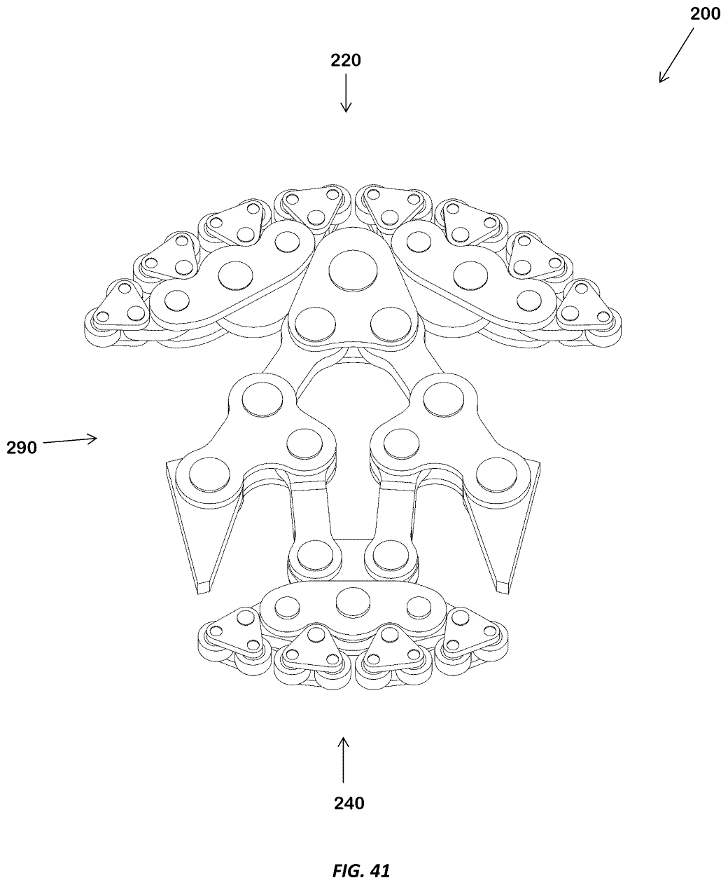

FIG. 41 is an upper 3D view of the embodiment illustrated in FIG. 1, illustrating only upper bearing segment assemblies front 220 and rear 240 and upper bearing linkage mechanism 290 between them, having a single row of rollers.

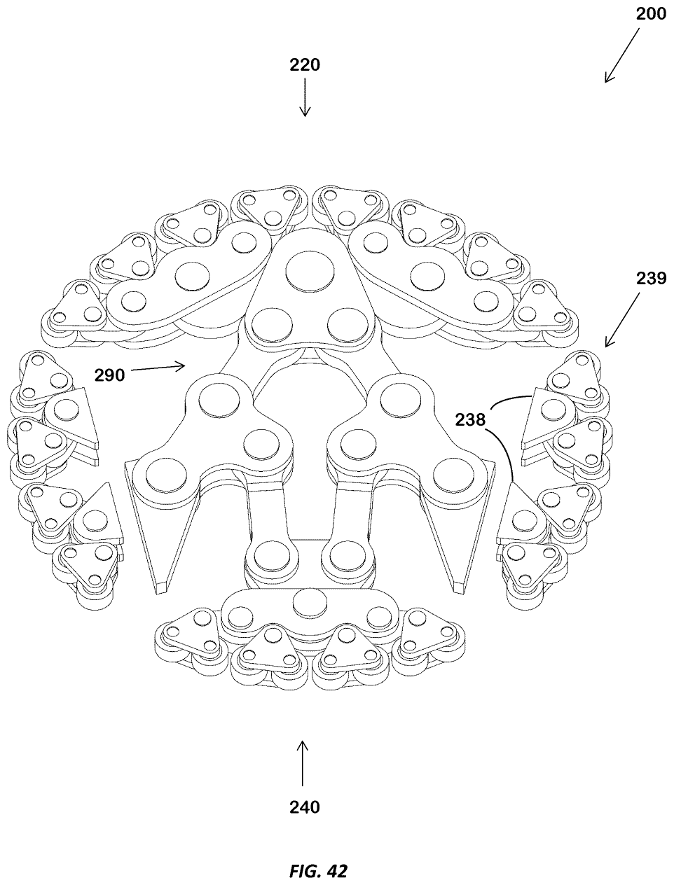

FIG. 42 is an upper 3D view of the embodiment illustrated in FIG. 1 illustrating the same components as FIG. 41 except having added a left and a right side stabilizer roller shoe assembly 238 with all rollers having a single row. A set of kingpost outboard mount lugs 239 connect these side roller assemblies to kingpost structure 110.

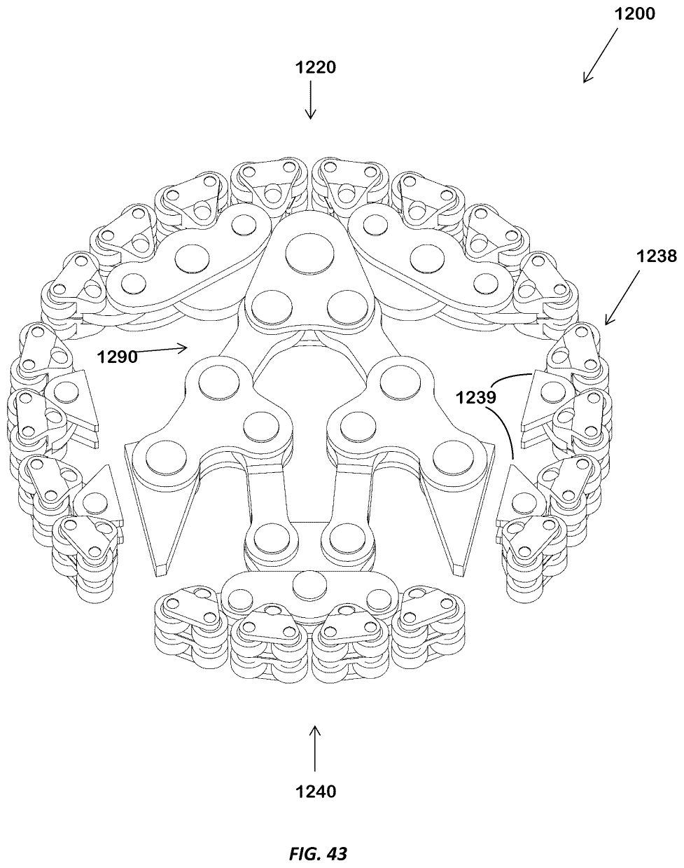

FIG. 43 is an upper 3D view of the embodiment illustrated in FIG. 1 illustrating only an alternate embodiment of an upper bearing assembly 1200, comprising a bearing assembly segment front 1220 and a rear 1240, and a left and a right side stabilizer roller spreader assembly 1238, all rollers having a double row. A set of outboard mount lugs 1239 connect these side roller assemblies to kingpost structure 110.

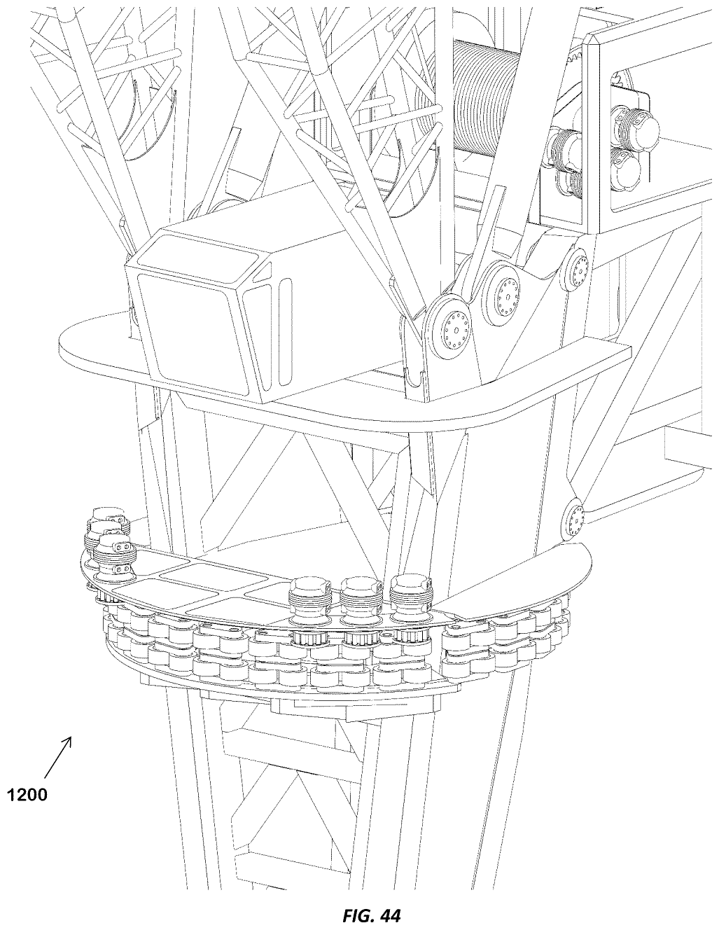

FIG. 44 is an upper 3D view of the embodiment illustrated in FIG. 1 and FIG. 43 illustrating double row upper bearing assembly 1200 which can be compared to FIG. 6 having only a single row.

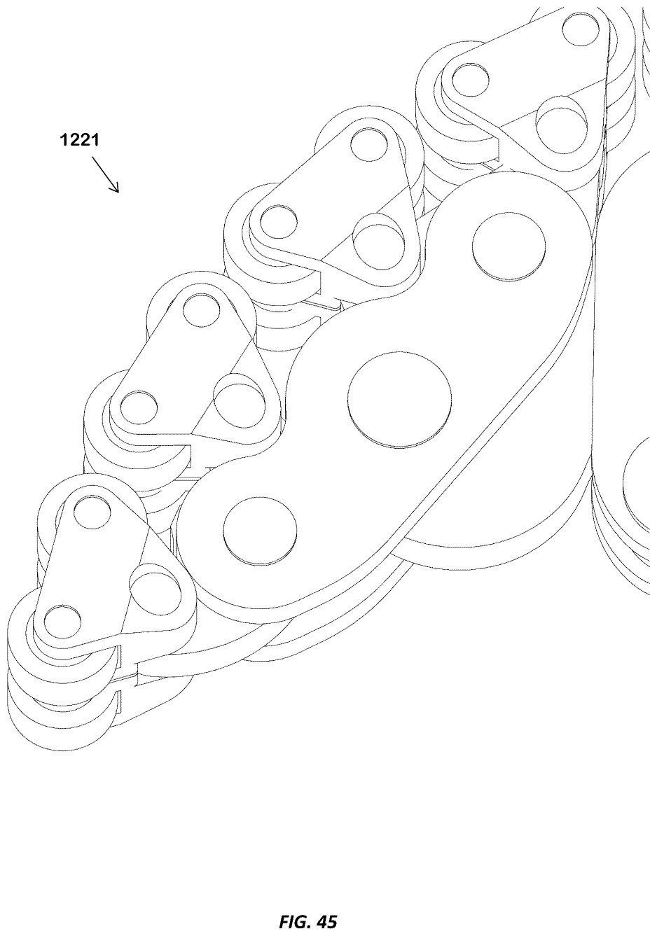

FIG. 45 is an upper 3D view of the embodiment illustrated in FIG. 1 and FIG. 43 illustrating a detail of a left double row upper bearing segment assembly 1221 comprising rollers pinned in a set of roller shoes 1228 (level 1) pinned to a set of spreaders 1230 (level 2) pinned to a set of larger spreaders 1232 (level 3) pinned to a set of even larger spreaders 1234 (level 4). This Figure can be compared to FIG. 20 showing front right upper bearing segment assembly 222 which is mirror symmetric with left segment 221 for single row bearings.

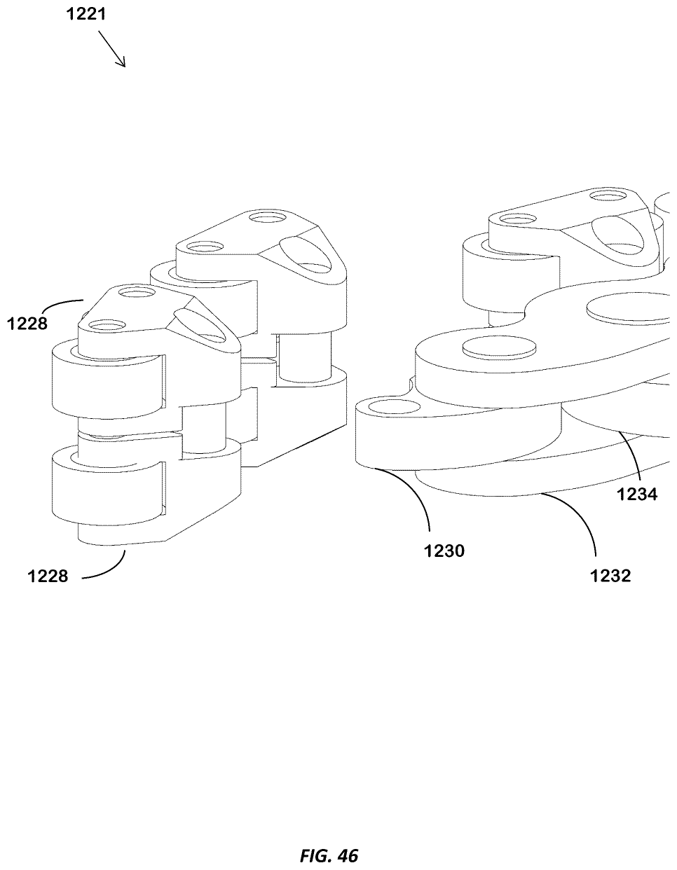

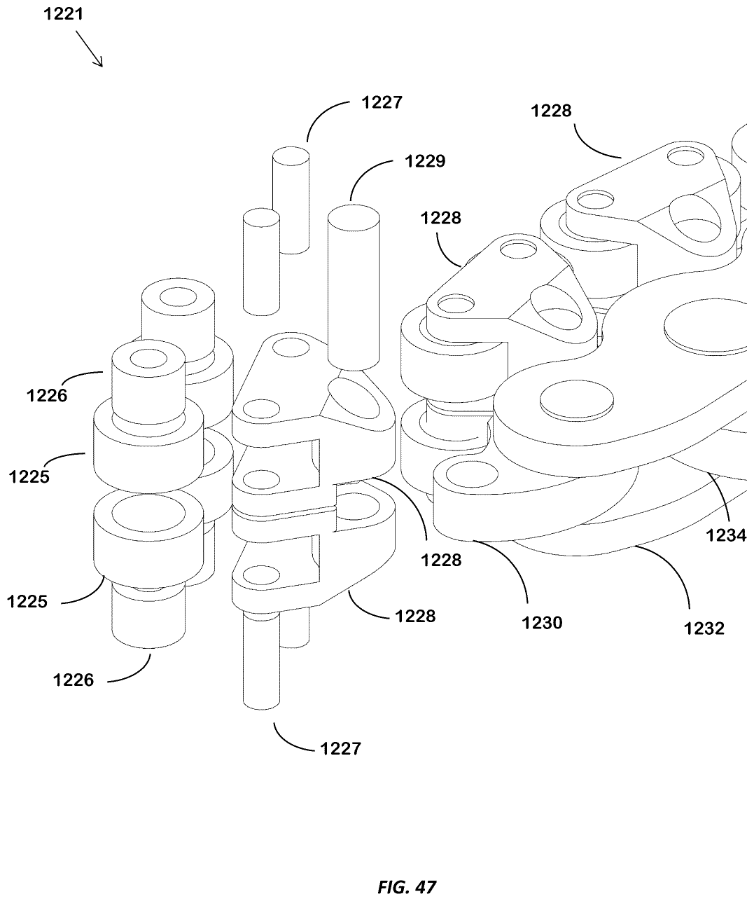

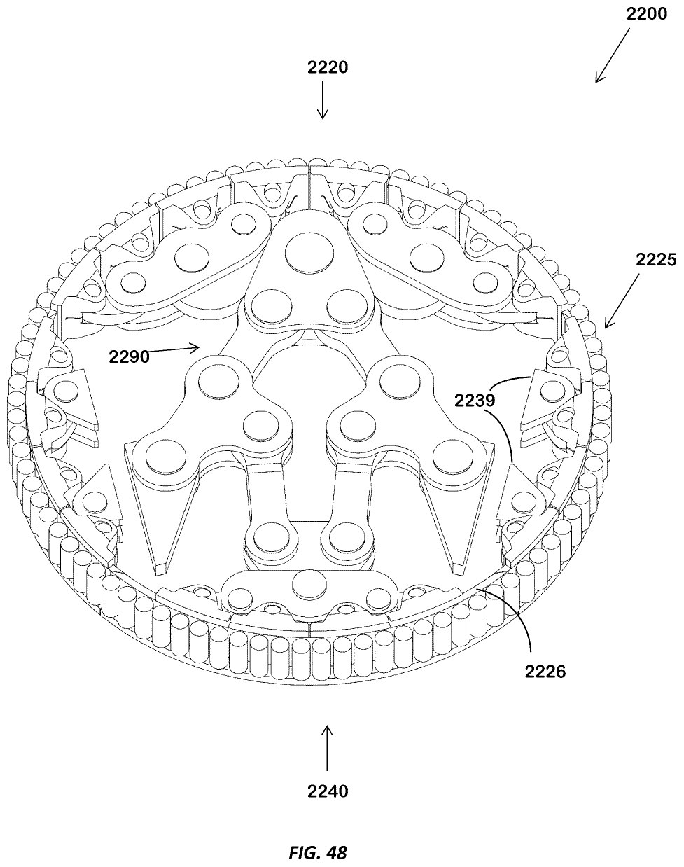

FIG. 46 is an upper 3D exploded view of the embodiment illustrated in FIG. 1 and FIG. 43 illustrating a detail of double row upper bearing assembly 1221 with roller shoes 1228 separated from their connecting spreader 1230 (level 2). To accommodate the loaded deformations that can misalign the roller contact with its race, it is preferred to mount a set of double-row rollers 1225 on a set of self-aligning bushings 1226 (FIG. 48) mounted on a set of pins 1227 (FIG. 47) through roller shoes 1228. It is also possible to use such bushings for other spreaders if more self-aligning capability is required.

FIG. 47 is an upper 3D exploded view of the embodiment illustrated in FIG. 1 and FIG. 43 illustrating a detail of double row upper bearing assembly 1221 with all parts connected to roller shoe 1228 comprising roller pin 1227, roller bushing 1226 and roller 1225. A roller shoe pivot pin 1229 is fit through transfer spreader 1230 (level 2) interconnected with similar connections to larger transfer spreaders 1232 (level 3) and that to an even larger one, spreader 1234 (level 4).

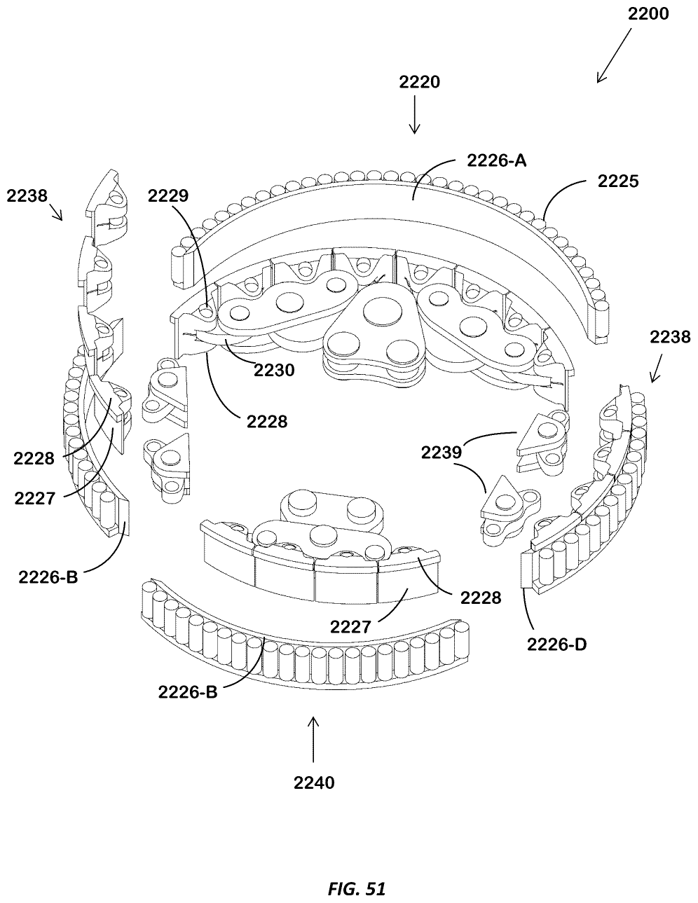

FIG. 48 is an upper 3D view of the embodiment illustrated in FIG. 1 illustrating an alternate embodiment of an upper bearing assembly 2200, comprised of an upper bearing assembly front 2220 and a rear 2240 with all spreaders identical to the embodiment illustrated in FIG. 43, except that roller shoes 1228 (double row) and their mounted rollers 1225, pivot pins 1226, bushings 1227, and pivot pins 1229 are removed. The removed components are replaced by a set of roller elements 2225 in between and in rolling contact with kingpost housing bearing outer race 301 and a loose, lightly constrained, roller race band 2226 or a segment thereof (segments enumerated in FIG. 51) functioning as a bearing inner race. As best illustrated in FIG. 51 a set of presser roller shoes 2228, having an outer contact surface 2227, are connected by a set of shoe pivot pins 2229 to a set of spreaders 2230, configured to direct equalized radial loading upon roller race band 2226 through its wall thickness and upon roller elements 2225.

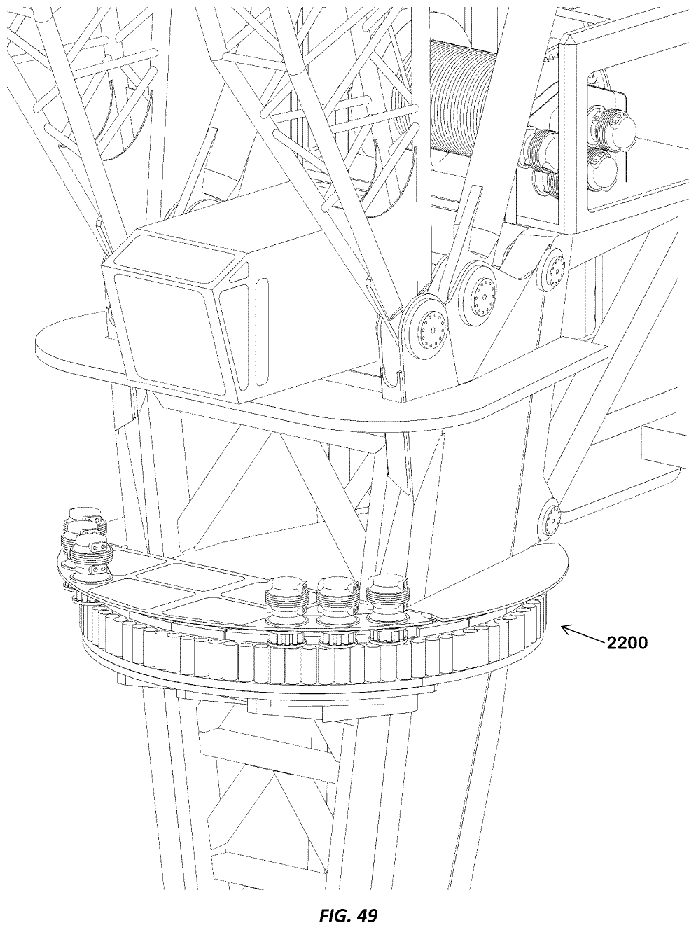

FIG. 49 is an upper 3D view of the embodiment illustrated in FIG. 1 and FIG. 48 illustrating rotating kingpost assembly 100 with upper bearing assembly 2200 which can be compared to FIGS. 6 and 44.

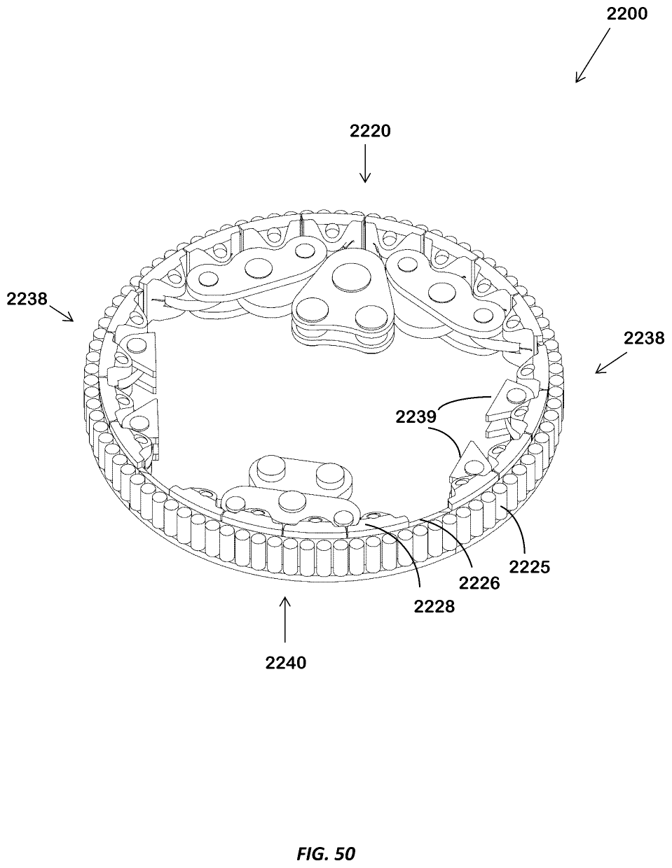

FIG. 50 is an upper 3D view of the embodiment illustrated in FIG. 1 and FIG. 48 illustrating upper bearing assembly 2200.

FIG. 51 is an upper 3D exploded view of the embodiment illustrated in FIG. 1 and FIG. 48 illustrating upper bearing assembly 2200 comprising upper bearing assemblies front 2220 and rear 2240, and a set of side roller stabilizing assemblies 2238, comprising roller elements 2225, presser shoe plate 2228 with recessed surface 2227, mounted by presser shoe pivot pin 2229 to transfer spreader 2230, and an alternate embodiment of roller race band 2226, which is a set of roller race band segments 2226-A, 2226-B, 2226-C and 2226-D.

Side roller stabilizer assemblies 2238 are mounted to kingpost assembly 100 at a set of pivot lugs 2239. This embodiment provides the opportunity to replace rollers 225 (single row) and rollers 1225 (double row) with simpler and possibly more economical roller elements 2225 (shaped as a cylindrical or possibly contoured as a barrel or toroidal segment) and replace their respective mount bushings 226 (single row) and 1226 (double row) and mount pins 227 (single row) and 1227 (double row) with inner race band 2227 while retaining the same equalizing load distribution afforded by the roller shoes 2228 and spreaders 2230, 2232 and 2234 as well as preloading and installation capabilities of bearing linkage mechanism 290 (single row) and 1290 (double row).

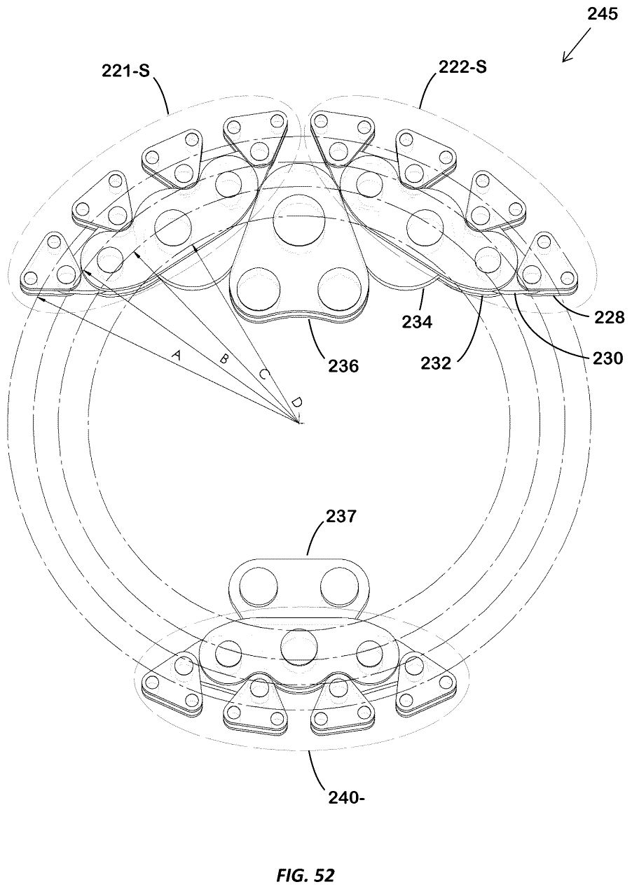

FIG. 52 is an upper 3D view of the embodiment illustrated in FIG. 1 and FIG. 7 illustrating the complete spreader assembly (245) of the upper bearing assembly (200) showing the three spreader segments 221-S, 222-S and 240-S interconnected by transition spreaders 234, 236 and 237 which also interconnect the spreader segments to the linkage mechanism (290), not shown. Some of the spreaders can be seen as under and between portions of other spreaders. The outermost spreaders are also called bearing shoes because they mount the bearing rollers.

The spreaders can be categorized by radius to their centroid, with this radius category shown as A, B, C and D in the figure, these radius values fit the inequality as follows:

### Radii A>B>C>D.

As well, spreaders are numbered as follows:
Spreaders of radius A are numbered as half the number of bearing rollers;
Spreaders of radius B are numbered as half the number of spreaders of radius A;
Spreaders of radius C are numbered as half the number of spreaders of radius B; and
Spreaders of radius D are numbered as half the number of spreaders of radius C.

This holds for if the number of rollers are equal to a base-two value such as 2⁴ or 2⁵; otherwise some special sized spreaders are required.

I claim:

1. A rotating kingpost and bearing assembly comprising:
a kingpost housing, the kingpost housing comprising:
a upper end and an opposite lower end:
a lower bearing mount at its lower end;
an upper collar located at its upper end;
a lower bearing box connectable to the lower bearing mount;
an upper bearing race located inside the upper collar;
a slew axis extending vertically through the centers of the lower bearing mount and the upper bearing race; and,
a rotating kingpost comprising:
an upper end an opposite lower end;
an axis coaxial with the slew axis;
a pair of linkage anchor lugs and at the elevation of the upper bearing race;
a lower bearing set located in the lower bearing box;
an upper bearing assembly engaged with the upper bearing race (301) of the kingpost housing, the upper bearing assembly comprising:
a spreader assembly comprising:
a plurality of spreader segments, each spreader segment having a plurality of bearing rollers attached thereto;
the bearing rollers engaged with the upper bearing race; and,
a linkage mechanism interconnecting the spreader assembly (245) and the linkage anchor lugs.

2. The rotating kingpost and bearing assembly of claim 1, the rotating kingpost (110) further comprising:
an axis coaxial with the slew axis (01);
an upper end (105), and an opposite lower end (195);
a left panel (111) having linkage anchor lug (298) affixed thereto;
a right panel (112) having linkage anchor lug (299) affixed thereto; and,
a front panel (113) and an opposite rear panel (114).

3. The rotating kingpost and bearing assembly of claim 1, further comprising: a spreader assembly (245) comprising:
a pair of nested spreader segments 221-S and 222-S each comprising:
a plurality of spreaders (228) of radius A each mounting a pair of bearing rollers (225) and pivotally connected to half as many spreaders (230) of radius B which are each pivotally connected to half as many spreaders (232) of radius C, where spreader centroids' radii are defined by the inequality:
radius A is greater than radius B which is greater than radius C; and
a transition spreader (236) connected to a transition spreader (234) which interconnects spreader segments 221-S and 222-S.

4. The rotating kingpost and bearing assembly of claim 1, the spreader assembly (245) further comprising:
a trio of nested spreader segments 221-S, 222-S or 240-S connected to transition spreaders (234), (236) and (237).

5. The rotating kingpost and bearing assembly of claim 1, further comprising: a linkage mechanism (290) comprising:
a symmetric, left and right, pair of toggle links (292) which rotate inward by actuator force (293) applied to drive link (291), radially expanding all three spreader assemblies (221, 222 and 240) into hard contact with the upper bearing race (301), effectively locking the front bearing assembly segments 221 and 222 into position; said rotation also applies radial force to the rear bearing segment (240).

6. The rotating kingpost and bearing assembly of claim 1, further comprising: a lower bearing mount affixed to the main support structure (500).

7. A rotating kingpost and bearing assembly comprising:
a kingpost housing (300) having an upper collar (310) and a lower bearing mount (330), the kingpost housing (300) connected to a main support structure (500);
a lower bearing box (259) is removable and connects to the lower bearing mount (330);
an upper bearing race (301) located inside the upper collar (310) of the kingpost housing (300);
a slew axis (01) extending vertically through the centers of the lower bearing mount (330) and the upper bearing race (301);
a rotating kingpost (110) having an axis coaxial with the slew axis (01), comprising:
an upper end (105) a lower end (195), a left panel (111) having linkage anchor lug (298) affixed to it, a right panel (112) having linkage anchor lug (299) affixed to it, a front panel (113) and a rear panel (114);
a lower bearing set (250) on the rotating kingpost lower end (195), mounted inside the lower bearing box (259);
an upper bearing assembly (200) engaged with the upper bearing race (301) of the kingpost housing (300); the upper bearing comprising:
a trio of bearing assembly segments (221), (222) and (240) comprising:
a plurality of bearing rollers (225)
a nested spreader assembly (245) interconnecting the bearing rollers (225) comprising:
a plurality of spreaders (228) of radius A each mounting a pair of bearing rollers (225) and pivotally connected to half as many spreaders (230) radius B which are each pivotally connected to half as many spreaders (232) radius C, where spreader centroids' radii are defined by the inequality:
radius A is greater than radius B which is greater than radius C;
a transition spreader (234) radius D, where radius C>radius D
a set of transition spreaders (236) and (237);
a linkage mechanism (290) comprising:
a symmetric, left and right, pair of toggle links (292) which rotate inward, rotatably connected to drive link (291) which is driven by actuator force (293) applied causing all three spreader assemblies (221, 222 and 240) to radially expand into hard contact with the upper bearing race (301), effectively locking the front bearing assembly segments 221 and 222 into position; and
said rotation also applies radial force to the rear bearing segment (240);
wherein the crane's various loads combine at the rotating kingpost (110) with a resultant horizontal couple force urging the welded linkage anchor lugs (298 and 299) to the front, applying force through the linkage mechanism (290) which transfers force-equalized loads through the spreader assembly (245) to the rollers (225) of the front roller bearing assembly sets (221 and 221) as equal radial loads, while the rear bearing assembly set (240) is in light contact and helps to stabilize the rotating kingpost (110) against inadvertent, reverse crane loading.
